(19) United States
(12) Patent Application Publication
(10) Pub. No.: US 2005/0036783 A1
(43) Pub. Date: Feb. 17, 2005

(54) Pattern production system, exposure system, and exposure method

(75) Inventors: Seiki Morita, Kanagawa-ken (JP); Daisuke Nakaya, Kanagawa-ken (JP); Mitsuru Sawano, Kanagawa-ken (JP); Atsushi Suganuma, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/903,583

(22) Filed: Aug. 2, 2004

(30) Foreign Application Priority Data
Jul. 31, 2003 (JP) (PAT.)204234/2003
Aug. 28, 2003 (JP) (PAT.)209336/2003

(51) Int. Cl. G03D 5/00

(52) U.S. Cl. 396/611

(57) ABSTRACT

In a pattern production system, resist coated on copper foil on the substrate is exposed to light, by direct drawing, on the basis of a width of a line forming a pattern designated by processing pattern data at a predetermined exposure, the exposed resist is developed to form a resist pattern, and the copper foil is etched to form an etched pattern. An image of the etched pattern is scanned and image information of the etched pattern is obtained. The width of the line forming the pattern represented by the image information and the width of the line forming the pattern of the target etched pattern are compared, and the width of the line forming the pattern designated by the processing pattern data is adjusted on the basis of the result of comparison. The resist is exposed to light, by direct drawing, with the adjusted line width on the basis of the result of comparison.

### BACKGROUND OF THE INVENTION

1. Field of the Invention

This invention relates to a pattern production system in which fluctuation in finish, for instance, in a circuit pattern of a printed circuit board due to deterioration of developer and/or etching liquid can be suppressed.

2. Description of the Related Art

For example, when producing a circuit pattern of a printed circuit board, in the past, a resist layer on a circuit board had been selectively exposed to light and solidified by the use of a photo-mask, the resist layer had been developed to form a resist pattern and the circuit pattern had been formed by etching copper foil on the substrate by the use of the resist pattern. In the conventional technology, there has been a problem that the amount of copper eroded by etching fluctuates depending on the line density of the resist pattern, which in turn fluctuates the width of the line forming the finished circuit pattern. In order to overcome this problem, there has been proposed, for instance, in Japanese Unexamined Patent Publication No. 6(1994)-186724, a method in which input data is corrected in advance according to the line density of the circuit pattern to be formed.

Further, when the width of the line forming the resist pattern is not larger than a predetermined width, over-etching occurs. In order to overcome this problem, there has been proposed, for instance, in Japanese Unexamined Patent Publication No. 2001-134627, a method in which a width of the line forming the resist pattern, at which the over-etching occurs, is measured in advance and a correction line is added to thicken the line of the resist pattern which is not thicker than the predetermined line width.

Further, the etching liquid can deteriorate after repeated use and the width of the line forming the etched circuit pattern can fluctuate. In order to overcome this problem, there has been proposed, for instance, in Japanese Unexamined Patent Publication No. 9(1997)-162522, a method in which a test pattern is embedded in an unused region of the circuit board (a region of the circuit board outside the circuit pattern), change in the amount of copper eroded by etching is detected by recognizing an image of the test pattern after etching and, for instance, supply of new etching liquid and/or the shower pressure of the etching liquid is controlled on the basis of the detected change in the amount of copper eroded by etching.

According to the methods disclosed in Japanese Unexamined Patent Publication Nos. 6(1994)-186724 and 2001-134627, though the width of the line forming the etched circuit pattern approximates a designated line width by correcting the line width represented by input data, the fluctuation in finish due to deterioration of developer or etching liquid after repeated use thereof cannot be suppressed. Further, the photo-mask must be remade a plurality of times in order to suppress the fluctuation in finish, for instance, due to deterioration of the etching liquid and the production cost rises.

The method disclosed in Japanese Unexamined Patent Publication No. 9(1997)-162522 attempts to control etching so that fluctuation in finish is suppressed by detecting the change in the eroded amount of the line by etching, which forms the pattern and controlling supply of new etching liquid and shower pressure. However, the method is disadvantageous in that due to instable response, control of supply of new etching liquid and/or the shower pressure of the etching liquid cannot fully remove the fluctuation in finish.

With increasing complication and/or increasing fineness of the circuit pattern, more precise finish recently has come to be desired and the fluctuation in finish, for instance, due to deterioration of the etching liquid has become unignorable.

### SUMMARY OF THE INVENTION

In view of the foregoing observations and description, the primary object of the present invention is to provide a pattern production system which can produce a pattern at high finish without affected by deterioration of the developer and the etching liquid or the like and without adding to the cost.

In accordance with an aspect of the present invention, there is provided a pattern production system comprising an exposure unit which exposes to light, by direct drawing on the basis of processing pattern data for forming a target etched pattern, resist coated on a material to be etched, on a substrate at a predetermined exposure, a developing unit which develops the exposed resist to form a resist pattern, an etching unit which forms an etched pattern by etching the material to be etched, and a correction unit which corrects the processing pattern data and/or the predetermined exposure on the basis of at least one or a combination of a difference between a shape of the resist pattern and a shape of a target resist pattern, a difference between a shape of the etched pattern and a shape of the target etched pattern, and an element which causes the difference.

The “processing pattern”, “resist pattern”, “etched pattern”, and “target etched pattern” are expressed by the coordinates and the width of the line forming the pattern.

The “target etched pattern” means an etched pattern to be formed and is expressed by the coordinates and the width of the line forming the pattern, and the “target resist pattern” means a resist pattern to be formed and is expressed by the coordinates and the width of the line forming the pattern.

The “material to be etched” means a material such as copper foil coated on a substrate, which is etched with etching liquid.

The correction unit may include an image recognition means which obtains image information by scanning the etched pattern after etching, a line width comparison means which compares a width of the line forming the pattern represented by the image information and a width of the line forming the target etched pattern, and an adjustment means for adjusting at least one of the predetermined exposure and a width of the line forming the pattern designated by the processing pattern data on the basis of the comparison result by the line width comparison means.

Alternatively, the correction unit may include an image recognition means which obtains image information by scanning the developed resist pattern, a line width comparison means which compares a width of the line forming the pattern represented by the image information and a width of the line forming the target resist pattern, and an adjustment means for adjusting at least one of the predetermined exposure and a width of a line forming the pattern designated by the processing pattern data on the basis of the comparison result by the line width comparison means.

The “adjustment of the width of the line forming the pattern designated by the processing pattern data” may be carried out by obtaining a value of correction and directly rewriting the processing pattern data so that the width of the line forming the pattern represented by the processing pattern data becomes a line width in which the value of correction is added to the width of the line represented by the processing pattern data or by separately obtaining adjusted line width in which the obtained value of correction is added to the line width designated by the processing pattern data without rewriting the processing pattern data directly.

The “comparison of the width of the line forming the pattern represented by the image information and the width of the line forming the pattern of the target etched pattern” may be carried out in any way so long as the difference between the width of the line forming the pattern represented by the image information and the width of the line forming the pattern of the target etched pattern can be detected. For example, the widths of the corresponding lines forming the patterns may be compared, or the areas of the corresponding lines forming the patterns may be compared. Further, for the comparison, either the difference therebetween or the proportion therebetween may be calculated.

Said adjustment means may store a relation between the value of correction for correcting the width of the line forming the pattern designated by the processing pattern data and the result of comparison and may obtain, on the basis of the relation, the value of correction corresponding to the result of comparison by the line width comparison means. Accordingly, said adjustment means may adjust the width of the line forming the pattern designated by the processing pattern data by the use of the value of correction.

The “result of comparison” means the result of comparison of the width of the line forming the pattern actually obtained by etching with the width of the target etched pattern or the result of comparison of the width of the line forming the resist pattern actually obtained by developing with the width of the line forming the target resist pattern. The “value of correction” means a value by which the width of the line forming the pattern designated by the processing pattern data is to be corrected to correct the width of the line forming the etched pattern after etching to the width of the line forming the target etched pattern or a value by which the width of the line forming the pattern designated by the processing pattern data is to be corrected to correct the width of the line forming the developed resist pattern to the width of the line forming the target resist pattern. Further, the “relation between the value of correction and the result of comparison” may be empirically obtained by actually measuring the width of the line forming the pattern of the etched pattern or the width of the line forming the pattern of the developed resist pattern. For example, relation obtained by etching or developing by the use of a test pattern including lines with various line widths, which form the pattern and measuring the width of the line forming the obtained pattern may be used.

Generally a pattern production system has a localism inherent to the system and even if the etched pattern or the resist pattern is made under the same condition, a different result can be obtained.

Accordingly, it is preferred that the line width comparison means obtains the result of comparison for each of the regions formed by dividing the target etched pattern into a plurality of regions, and the adjustment means stores the relation between the value of correction for correcting the width of the line forming the pattern designated by the processing pattern data and the result of comparison for each of the regions, obtains, on the basis of the relation, the value of correction corresponding to the result of comparison for each of the regions, obtained by the line width comparison means and adjusts the width of the line forming the pattern designated by the processing pattern data by the use of the value of correction for each of the regions.

Further, said adjustment means may store a relation between the value of correction of the predetermined exposure and the result of comparison, obtain, on the basis of the relation, the value of correction of the predetermined exposure corresponding to the result of comparison by the line width comparison means, and adjust the predetermined exposure by the use of the value of correction.

Further, the “relation between the value of correction and the result of comparison” may be empirically obtained, for instance, by measuring the width of the line forming the pattern of the etched pattern after actual etching or the width of the line forming the pattern of the developed resist pattern. For example, relation obtained by etching or developing by the use of a test pattern including lines with various line widths, which form the pattern and measuring the width of the line forming the obtained pattern may be used.

The correction unit may include deterioration detecting means which detects deterioration of the developer used by the developing unit, and an adjustment means which adjusts at least one of the predetermined exposure and the width of the line forming the pattern designated by the processing pattern data on the basis of the result of detection by the deterioration detecting means.

The deterioration detecting means may comprise a measuring means which measures the amount of resist dissolved in the developer used by the developing unit, and may detect deterioration of the developer on the basis of the result of measurement by the measuring means.

The “amount of resist dissolved” in the developer can be measured by neutralization titration, for example.

Further, the deterioration detecting means may detect deterioration of the developer on the basis of the total processed area of the circuit board, developed by the developing unit.

The “total processed area” is the total of the areas of the resist on the surface of the circuit board, dissolved by the developer, which can be obtained from the area over which the exposure system has drawn on the resist or can be approximated from the number of circuit boards which have been processed by the developer.

The deterioration detecting means may comprise a measuring means which measures the pH value of the developer used by the developing unit, and may detect deterioration of the developer on the basis of the result of measurement by the measuring means.

Said adjustment means may store a relation between the value of correction for correcting the width of the line forming the pattern and the deterioration of the developer used by the developing unit, obtain, on the basis of the relation, the value of correction corresponding to the result of detection by the deterioration detecting means, and adjust the width of the line forming the pattern designated by the processing pattern data by the use of the value of correction.

The “value of correction” is a value by which the width of the line forming the pattern designated by the processing pattern data is corrected so that the width of the line forming the developed resist pattern becomes a desired line width. The “relation between the value of correction and the result of comparison” may be empirically obtained by actually measuring the width of the line forming the pattern of the developed resist pattern. For example, relation obtained by developing by the use of a test pattern including lines with various line widths, which form the pattern, and measuring the width of the line forming the obtained pattern may be used.

Generally a pattern production system has a localism inherent to the system and even if the etched pattern or the resist pattern is made under the same condition, a different result can be obtained.

Accordingly, it is preferred that the adjustment means stores the relation between the deterioration of the developer used by the developing unit and the value of correction by which the width of the line forming the pattern is corrected for each of the regions formed by dividing the circuit board into a plurality of regions, obtains, on the basis of the relation, the value of correction corresponding to the deterioration according to the result of detection by the deterioration detecting means, and adjusts the width of the line forming the pattern designated by the processing pattern data by the use of the value of correction for each of the regions.

Further, said adjustment means may store a relation between the deterioration of the developer used by the developing unit and the value of correction of the predetermined exposure, obtain, on the basis of the relation, the value of correction corresponding to the deterioration according to the result of detection detected by the deterioration detecting means, and adjust the predetermined exposure by the use of the value of correction.

The correction unit may include deterioration detecting means which detects deterioration of the etching liquid used by the etching unit and an adjustment means which adjusts at least one of the predetermined exposure and the width of the line forming the pattern designated by the processing pattern data on the basis of the result of detection by the deterioration detecting means.

With deterioration of the etching liquid, the amount of the copper foil on the substrate, eroded by etching is reduced and the width of the line forming the etched pattern changes. Accordingly, the “result of detection” which is a result of detecting the deterioration of the etching liquid may be of any value representing the etching power of the etching liquid including, for instance, the pH of the etching liquid.

The deterioration detecting means may comprise a measuring means which measures the pH of the etching liquid used by the etching unit, and may detect deterioration of the etching liquid on the basis of the result of measurement by the measuring means.

Said adjustment means may store a relation between the value of correction for correcting the width of the line forming the pattern and the deterioration of the etching liquid used by the etching means, obtain, on the basis of the relation, the value of correction corresponding to the result of detection by the deterioration detecting means, and adjust the width of the line forming the pattern designated by the processing pattern data by the use of the value of correction.

The adjustment means may store the relation between the deterioration of the etching liquid used by the etching unit and the value of correction by which the width of the line forming the pattern is corrected for each of the regions formed by dividing the circuit board into a plurality of regions, obtain, on the basis of the relation, the value of correction corresponding to the deterioration according to the result of detection by the deterioration detecting means for each of the regions, and adjust the width of the line forming the pattern designated by the processing pattern data by the use of the value of correction for each of the regions.

Further, said adjustment means may store a relation between the value of correction of the predetermined exposure and the deterioration of the etching liquid used by the etching unit, obtain, on the basis of the relation, the value of correction of the predetermined exposure corresponding to the deterioration according to the result of detection by the deterioration detecting means, and adjust the predetermined exposure by the use of the value of correction.

An exposure system according to another aspect of the present invention may comprise an exposure unit which exposes to light, by direct drawing on the basis of processing pattern data for forming a target etched pattern through developing and etching, resist coated on a material to be etched, on a substrate at a predetermined exposure, a difference information obtainment unit for obtaining difference information including at least one of a difference between a shape of the developed resist pattern and a shape of a target resist pattern, a difference between a shape of the etched pattern and a shape of the target etched pattern, and an element which causes the difference, and a correction unit which corrects the processing pattern data and/or the predetermined exposure on the basis of the difference information.

The difference information obtainment unit may obtain the difference information by comparing the image information of the resist pattern and the shape of the target resist pattern and/or comparing the image information of the etched pattern and the shape of the target etched pattern.

The difference information obtainment unit may include a unit for obtaining the image information.

The difference information obtainment unit may obtain the difference information on the basis of the condition of the developer and/or the etching liquid.

The difference information obtainment unit may include a unit for detecting the condition of the developer and/or the etching liquid.

The difference information obtainment unit may include a unit for detecting the difference information on the basis of a number of times of developing by the use of the same developer and/or a number of times of etching by the use of the same etching liquid.

The difference information obtainment unit may obtain the difference information on the basis of a number of times of developing by the use of the same developer and/or a number of times of etching by the use of the same etching liquid.

The difference information obtainment unit may detect the difference information on the basis of a number of times of developing by the use of the same developer and/or a number of times of etching by the use of the same etching liquid and a size of the circuit board.

The difference information obtainment unit may detect the difference information on the basis of a number of times of developing by the use of the same developer and/or a number of times of etching by the use of the same etching liquid and an area on a surface of the circuit board, on which development and/or etching is carried out.

The difference information obtainment unit may include a unit for obtaining the number of times of developing by the use of the same developer and the number of times of etching by the use of the same etching liquid on the basis of the number of times of exposure.

The difference information obtainment unit may obtain the difference information on the basis of the number of times of exposure.

It is preferable that the difference information obtainment unit includes a first obtainment unit for obtaining the difference information by comparing the image information of the resist pattern and the shape of the target resist pattern and/or comparing the image information of the etched pattern and the shape of the target etched pattern and a second obtainment unit for obtaining the difference information on the basis of the number of times of exposure and further includes a switching unit for switching the obtainment between the obtainment by the first obtainment unit and the obtainment by the second obtainment unit.

The switching unit may switch the obtainment of the difference information between the obtainment by the first obtainment unit and the obtainment by the second obtainment unit every predetermined number of obtainment.

The correction unit may carry out the correction for each of the regions formed by dividing the surface of the circuit board.

The difference information obtainment unit may obtain the difference information for a part of the surface of the circuit board.

An exposure method according another aspect of the present invention is a method for exposing to light, by direct drawing on the basis of processing pattern data for forming a target etched pattern through development and etching, resist coated on a material to be etched on a substrate at a predetermined exposure. The method may include the steps of obtaining difference information including at least one of a difference between a shape of the resist pattern and a shape of a target resist pattern, a difference between a shape of the etched pattern and a shape of the target etched pattern, and an element which causes the difference, and correcting the processing pattern data and/or the predetermined exposure on the basis of the difference information.

The difference information may be obtained by comparing the image information of the resist pattern and the shape of the target resist pattern and/or comparing the image information of the etched pattern and the shape of the target etched pattern.

The difference information may be obtained on the basis of the condition of the developer and/or the etching liquid.

The difference information may be obtained on the basis of the number of times of developing by the use of the same developer and/or the number of times of etching by the use of the same etching liquid.

The difference information may be obtained on the basis of the number of times of exposure.

In the pattern production system of an aspect of the present invention, the image information obtained by scanning the etched pattern after etching and the target etched pattern, which is required to be formed after etching are compared with each other. When the conformity of the actual etched pattern with the target etched pattern is not acceptable, the predetermined exposure and/or the width of the line forming the pattern designated by the processing pattern data is adjusted and the resist is exposed to light, by direct drawing by the use of a direct drawing exposure system, at the adjusted exposure and/or with the adjusted line width. Accordingly, fluctuation in finish due to, for instance, deterioration of the developer or the etching liquid can be suppressed.

If the resist is exposed to light through a mask pattern depicted on a film or glass substrate as in a conventional method, it is necessary to often remake the mask pattern to deal with such fluctuation, which adds to the cost. However, by exposing the resist to light, by direct drawing by the use of a direct drawing exposure system, at the adjusted exposure and/or with the adjusted line width, uniform finish can be obtained without adding to the cost.

In the pattern production system of another aspect of the present invention, by comparing the image information obtained by scanning the developed resist pattern with the target resist pattern, which is required to be formed after development, fluctuation in finish generated up to the development step can be detected and corrected.

If the fluctuation in finish generated in both of the etching step and the development step becomes able to be detected, the width of the line formed by the pattern designated by the processing pattern data and the exposure become able to be adjusted according to the step where the fluctuation was generated. Therefore, the correction can be carried out in a more appropriate manner.

Further, when an actually measured relation is stored as the relation between the value of correction of the width of the line forming the pattern and the result of comparison, correction conforming to each of production systems can be carried out.

Further, if the relation between the value of correction, by which the width of the line forming the pattern is corrected and the result of comparison is stored for each of the regions formed by dividing the circuit board into a plurality of regions, the correction can be made to nullify the localism inherent to the production system, which results in more precise and more uniform finish.

Further, when actually measured relation is stored as the relation between the value of correction for correcting the predetermined exposure and the result of comparison such as a difference obtained by comparison, correction conforming to the production system can be carried out also by adjusting the exposure.

Deterioration of the developer or the etching liquid is detected, and the predetermined exposure and/or the line width of the line forming the pattern designated by the processing pattern data is adjusted on the basis of the result of detection and the resist is exposed to light, by direct drawing by the use of a direct drawing exposure system, at the adjusted exposure and/or with the adjusted line width. Accordingly, fluctuation in finish due to, for instance, deterioration of the developer or the etching liquid can be suppressed.

When deterioration of the developer is indirectly detected from the area of the developed resist, deterioration of the developer can be detected on the basis of total area exposed by the exposure system or the number of processed circuit boards without providing a detecting system which directly detects deterioration of the developer.

Deterioration of the developer or the etching liquid can be detected by measuring the pH of the developer or the etching liquid.

When an actually measured relation is stored as the relation between the value of correction of the width of the line forming the pattern and the result of detection, correction conforming to the production system can be carried out.

### BRIEF DESCRIPTION OF THE DRAWINGS

FIG. 1 is a block diagram showing a pattern production system in accordance with a first embodiment of the present invention,

FIG. 2 is a block diagram showing the structure of the exposure system employed in the first embodiment,

FIG. 3 is a view showing a laser direct drawing system,

FIG. 4 is a flow chart for illustrating the operation of the pattern production system of the first embodiment,

FIG. 5 is a view for illustrating regions of the surface of the circuit board,

FIG. 6 is a view for illustrating comparison of the line width,

FIG. 7 is a view showing a relation between the difference between the line width of the actually etched pattern and the target line width and the value of correction,

FIG. 8 is a view for illustrating comparison of the line width,

FIG. 9 is a view showing a relation between the value of correction of the line width and the value of correction of the exposure,

FIG. 10 is a block diagram showing a pattern production system in accordance with a second embodiment of the present invention,

FIG. 11 is a block diagram showing the structure of the exposure system employed in the second embodiment,

FIG. 12 is a block diagram showing a pattern production system in accordance with a third embodiment of the present invention,

FIG. 13 is a view showing the pH value change versus the amount of titrated HCl,

FIG. 14 is a block diagram showing the structure of the exposure system employed in the third embodiment,

FIG. 15 is a flow chart for illustrating the operation of the pattern production system of the third embodiment,

FIG. 16 is a graph showing a relation between the amount of resist dissolved in the developer and the value of correction of the line forming the pattern represented by the processing pattern data,

FIG. 17 is a view for illustrating regions of the surface of the circuit board,

FIG. 18 is a graph showing a relation between the value of correction of the line width and the value of correction of exposure,

FIG. 19 is a block diagram showing a pattern production system in accordance with a fourth embodiment of the present invention,

FIG. 20 is a block diagram showing the structure of the exposure system employed in the fourth embodiment,

FIG. 21 is a graph showing a relation between the developed resist area and the amount of resist dissolved in the developer,

FIG. 22 is a block diagram showing a pattern production system in accordance with a fifth embodiment of the present invention,

FIG. 23 is a block diagram showing the structure of the exposure system employed in the fifth embodiment,

FIG. 24 is a block diagram showing a pattern production system in accordance with a sixth embodiment of the present invention, and

FIG. 25 is a block diagram showing the structure of the exposure system employed in the sixth embodiment.

### DESCRIPTION OF THE PREFERRED EMBODIMENTS

A pattern production system in accordance with a first embodiment of the present invention will be described with reference to the drawings.

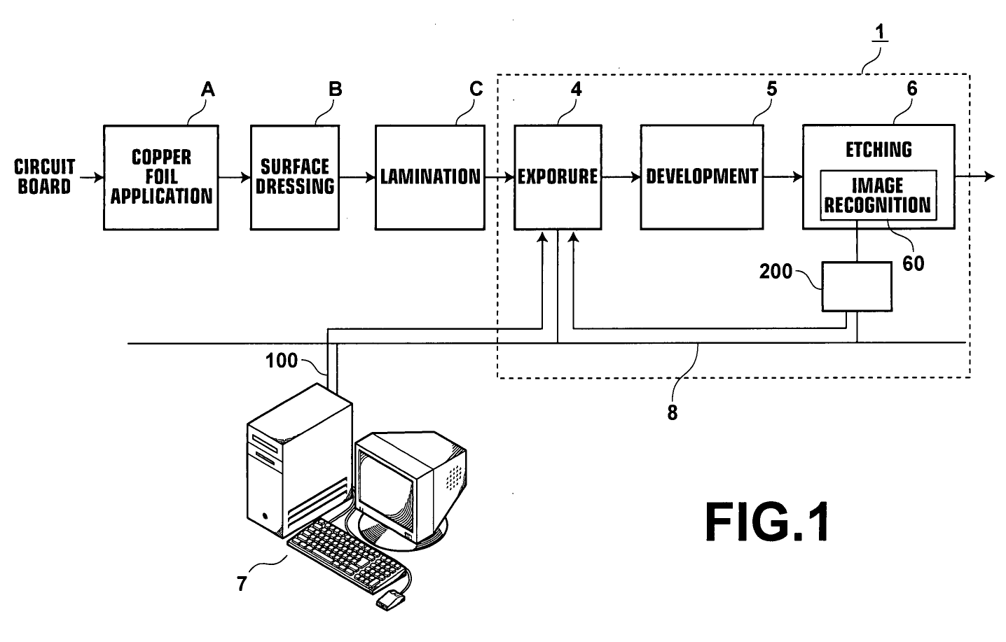

FIG. 1 is a block diagram showing a pattern production system 1 in accordance with a first embodiment of the present invention. Production of a circuit pattern (an etched pattern) by the pattern production system 1 will be described, hereinbelow. First, copper foil, which is a circuit formation material, is applied to a circuit board in copper foil applying step A. The upper surface of the copper foil is dressed by mechanical polishing, chemical polishing or the like in surface dressing step B. Then resist (resist material) is laminated on the dressed upper surface of the copper foil in lamination step C. Thereafter, by the pattern production system 1 in accordance with the first embodiment of the present invention, a desired etched pattern is formed by exposing to light the resist on the circuit board, developing the exposed resist to form a resist pattern and etching the copper foil on the substrate, on which the resist pattern is formed, to form an etched pattern.

The pattern production system 1 comprises a direct drawing exposure system (exposure unit) 4 which exposes to light the resist laminated on the copper foil, a developing system (developing unit) 5 which develops the exposed resist to form a resist pattern and an etching system (etching unit) 6 which etches the copper foil on the substrate, on which the resist pattern is formed, to form an etched pattern.

The etching system 6 is provided with an image recognition system (image recognition means) 60 which may be an optical inspection machine (AOI) employing a CCD camera so that image information 200 representing the etched pattern formed by etching the copper foil can be obtained by scanning, and the image recognition system 60 is connected to the exposure system 4 by way of a network 8. The image information 200 is sent from the image recognition system 60 to the exposure system 4.

A target etched pattern (a circuit pattern to be actually formed) which has been designed by the use of a CAD (computer-aided design) is taken in by a CAM (computer-aided manufacturing) 7. In the CAM 7, the target etched pattern is added with additional information such as layout of the target etched pattern, marking for location, symbol data for identification, dummy data for uniforming the pattern, and the like, and converted to the processing pattern data (e.g., Gerber data) 100 including the values of the coordinates and the width of the line for processing the circuit pattern. Then the processing pattern data 100 is output to the exposure system 4.

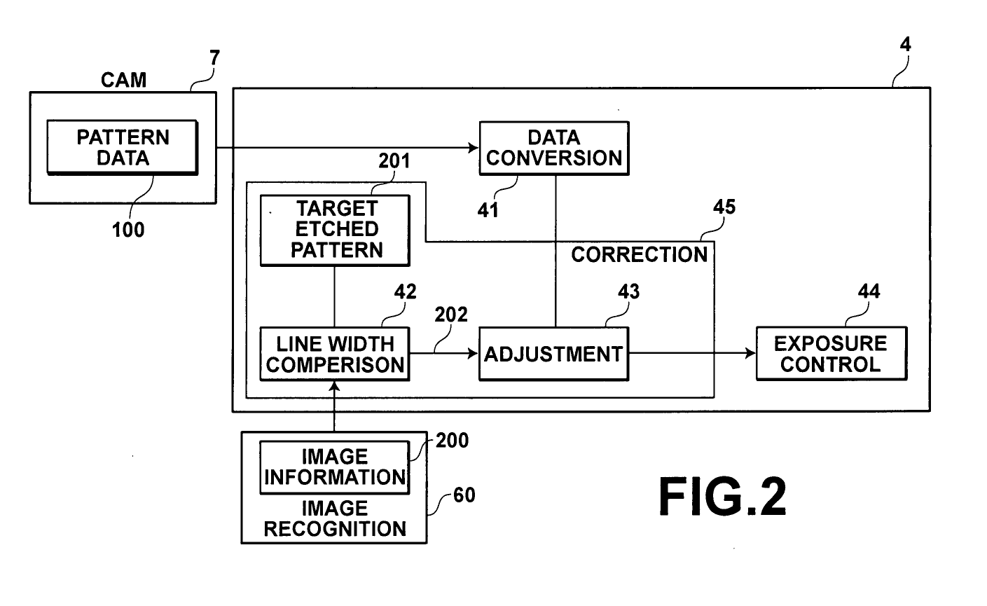

As shown in FIG. 2, the exposure system 4 comprises a data conversion means 41 which converts the processing pattern data 100 input from the CAM 7 to data of a format suitable for processing, a correction unit 45 which corrects the processing pattern data and exposure at the exposure system to produce a finished circuit pattern in conformity with the design, and an exposure control means (including therein the light source for exposure) 44 which exposes the resist to light according to the processing pattern data 100. Hereinafter, a case of providing the correction means 45 in the exposure system 4 will be described in this embodiment. However, a correction system (correction unit) including the correction means 45 provided in another computer may be connected to the exposure system 4.

Further, the correction means 45 includes a line width comparison means (difference information obtainment unit) 42 which obtains a comparison result (difference information) 202a by comparing the image information 200 recognized at the image recognition system 60 after etching and a target etched pattern 201 and an adjustment means 43a which adjusts the processing pattern data 100 and the exposure so that the etched pattern approximates to the target etched pattern 201 on the basis of the obtained comparison result 202a.

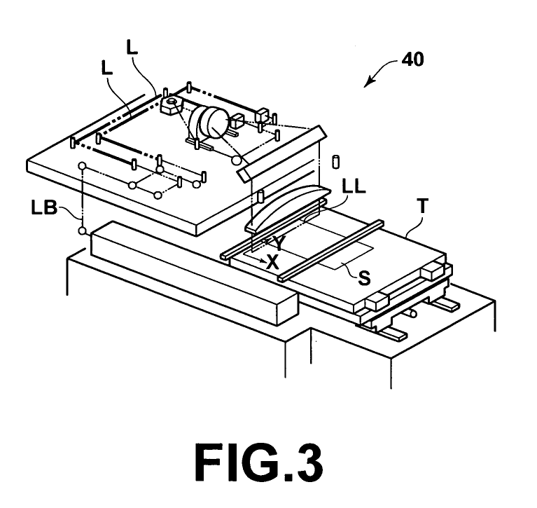

As the exposure system 4, a direct drawing system, which directly forms an image on the resist by the use of, for instance, a laser beam, is employed. For example, a laser direct drawing system 40, as shown in FIG. 3, is arranged to split a laser beam LB emitted from a laser into a plurality of drawing beam bundles L by way of a beam splitter and/or a beam separator and to cause the split beam bundles L to reach a drawing table T as a drawing beam bundle LL where the split beam bundles L are linearly arranged. The laser direct drawing system 40 causes the drawing bundle LL to scan a circuit board S in the main scanning direction (the direction of arrow Y) and in the sub-scanning direction (the direction of arrow X) to form an image by linearly arranged dots on the circuit board S. The laser direct drawing system 40 is disclosed in detail, for instance, in Japanese Unexamined Patent Publication Nos. 7(1995)-15993 and 9(1997)-323180. Alternatively, a spatial light modulation device such as an LCD (Liquid Crystal Device) and a DMD (Digital micro-mirror Device) may be used as the direct drawing exposure system.

When an image is formed on the resist on the circuit board with the laser drawing system 40, the processing pattern data 100 converted to raster data is used as drawing data, and the exposure control means 44 selectively exposes the resist on the basis of the drawing data. Though the resist is normally exposed on the basis of standard exposure set in the exposure system, exposure can be adjusted as desired. In order to adjust exposure, though exposure obtained by the adjustment means 43 may be transferred to the exposure control means 44 as information separate from the drawing data, when each of the pixels of the drawing data is expressed in a multi-value, the exposure obtained by the adjustment means 43 can be transferred to the exposure control means 44 by converting the drawing data to multi-valued data corresponding to the exposure obtained by the adjustment means 43. (For instance, a pixel is expressed in 255 gradations and as the value decreases, the exposure is reduced with 255 representing a maximum exposure.)

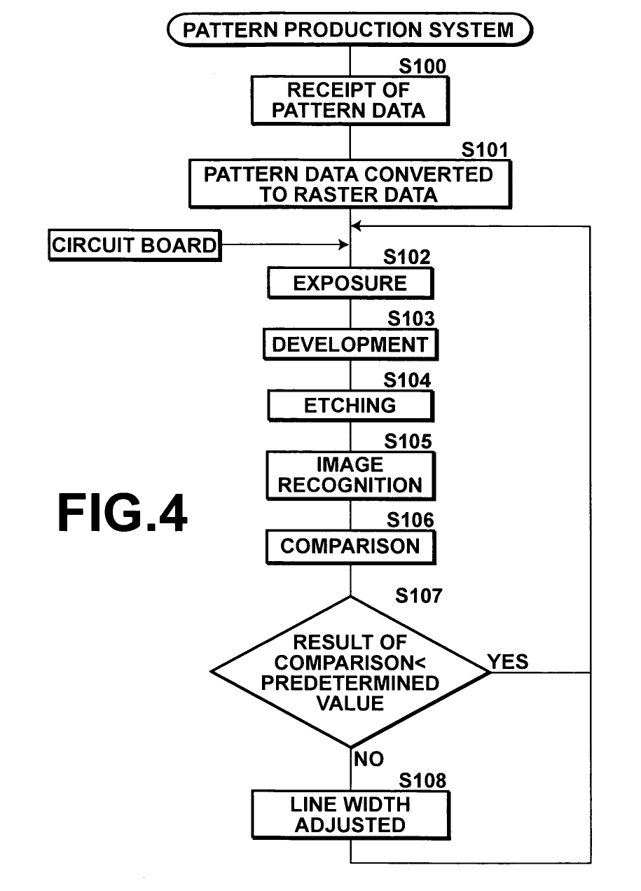

Repeated production of the same circuit pattern by the use of the pattern production system 1 of this embodiment will be described with reference to the flow chart shown in FIG. 4, hereinbelow.

The exposure system 4 receives the processing pattern data 100 from the CAM (step S100). The exposure system 4 converts the processing pattern data 100 in a vector data format such as of Gerber data into processing pattern data (drawing data) in a raster data format by the data conversion means 41 (step S101) and exposes to light the resist on the copper foil on the substrate by the exposure control means 44 (step S102).

After exposure to light of the resist coated on the copper foil on the substrate, the developing system 5 develops the exposed resist (in the case of positive resist, the exposed part is removed, whereas in the case of negative resist, the unexposed part is removed) to form a resist pattern on the upper surface of the copper foil (step S103). Then, the etching system 6 etches the copper foil on the substrate, bearing thereon the resist pattern, thereby forming an etched pattern (step S104). The image recognition system 60 scans the formed etched pattern (step S105) and the image information 200 obtained is transferred to the exposure system 4.

In the exposure system 4, the line width comparison means 42 compares the line width represented by the image information 200 obtained by the image recognition system 60 with that represented by the target etched pattern 201 which has been stored therein (step S106) The processing pattern data 100 for processing often has been corrected by, for instance, a CAM so that the etched pattern has a line width substantially equal to that designated by the target etched pattern 201 (for instance, locally thickened or thinned as compared with the line width designated upon design) taking into account various processing conditions such as the intervals of the pattern lines (density of the pattern lines), exposure, condition of the developer, condition of the etching liquid and the like. Accordingly, data representing a target line width is received in advance from the CAD (not shown) or the CAM 7 as the target etched pattern 201 separate from the processing pattern data 100 and stored in advance.

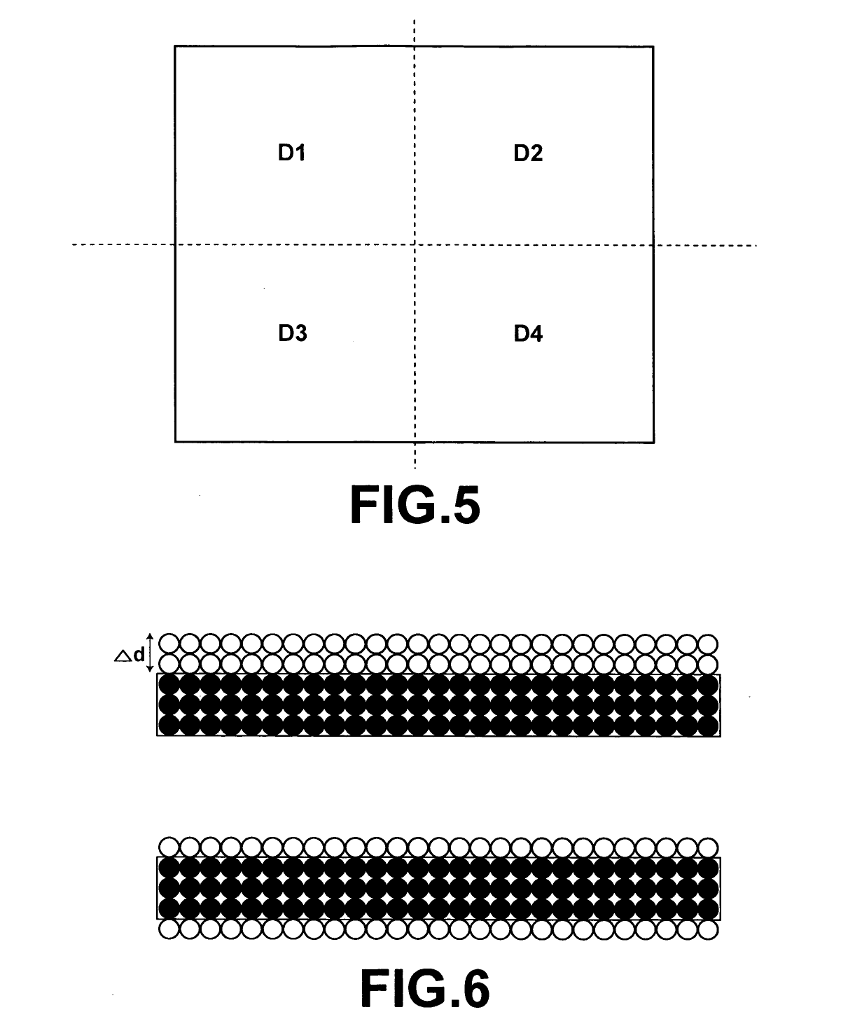

In order for the line width comparison means 42 to compare the line width represented by the image information 200 with that represented by the target etched pattern 201, the area on the circuit board, which is to be set on the exposure system, the developing system and the etching system sequentially for processing, is divided into, for instance, a plurality of regions (D1, D2, D3 and D4) as shown in FIG. 5. Further, the target etched pattern 201 is divided into a plurality of regions (D1, D2, D3 and D4) to correspond to the regions on the circuit board. Then comparison is made for each of the corresponding regions (D1, D2, D3 and D4).

When the target etched pattern 201 has been stored as raster data, the image information 200 (bit map) and the target etched pattern 201 are superposed by region and the number of dots (the part represented by ∘) covering the part which is not superposed is counted (• in FIG. 6 represents a part which is superposed and ∘ represents a part which is not superposed), and the difference in the line width between the former and the latter or the difference (or ratio) in the area therebetween is calculated. For example, as shown in FIG. 6, when the difference in line width Δd in a certain region is two dots, the correction is made on the basis of two dots. When the image information 200 and the target etched pattern 201 are superposed, the difference can be either 2 dots or 3 dots within the same region, depending on the pattern lines. When the difference in line width Δd fluctuates in one region, the correction is made on the basis of the average or the representative value (frequently generated difference) of the differences.

When the target etched pattern 201 has been stored as vector data, it is possible to approximate the line width from the image information 200 and to obtain the difference from the line width (or the area) represented by the target etched pattern 201.

When the result of comparison 202 thus obtained (the difference between the line width represented by the image information 200 and that represented by the target etched pattern 201) is smaller than a predetermined value (step S107-YES), the next circuit board is processed by the use of the processing pattern data 100 as it is, whereas when the difference between the line width represented by the image information 200 and that represented by the target etched pattern 201 is not smaller than the predetermined value (step S107—NO), the processing pattern data 100 must be corrected.

The adjustment means 43 adjusts the width of the line forming the pattern designated by the processing pattern data 100 and/or the exposure on the basis of the result of comparison 202 obtained by the line width comparison means 42 so that the width of the line forming the etched pattern becomes equal to the target line width (the line width of the target etched pattern) (step S108).

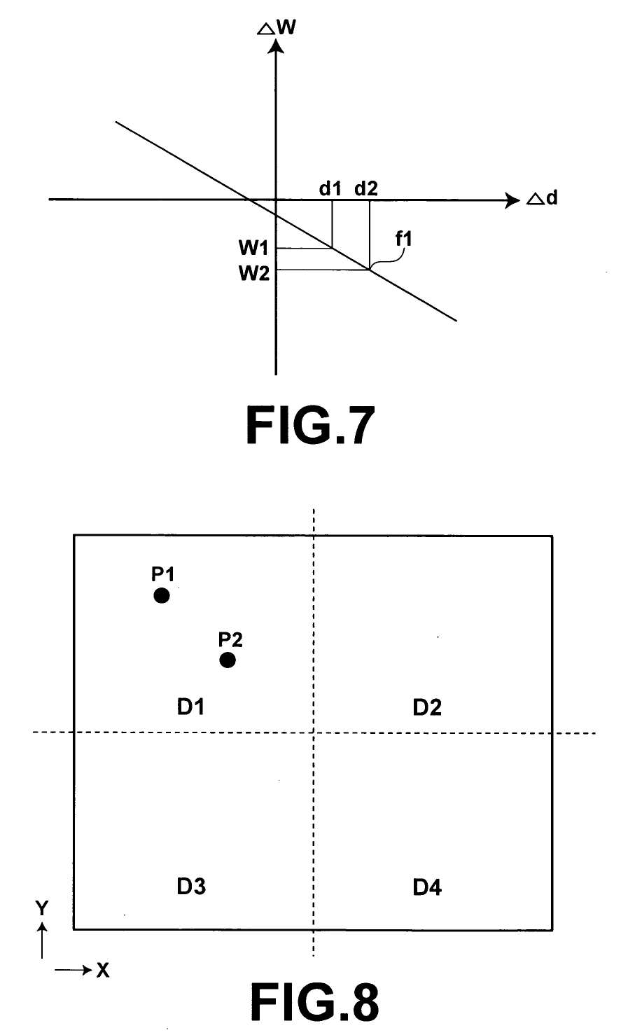

The difference Δd between the actually formed line width and the target line width has relation with the value of correction ΔW which is, for instance, shown in FIG. 7 and is represented by the following formula (1):
ΔW=f1(Δd) (1).

The value of correction ΔW is a value by which the width of the line forming the pattern of the processing pattern data 100 is corrected to nullify the difference.

This relation has been stored on the basis of the empirical knowledge, a result of actual production, or the like and the adjustment is carried out on the basis of the stored relation.

Localism that the width of the line of the formed pattern differs by the place on the circuit board can be generated due to the circulation of the developer or the etching liquid, the shower pressure, the direction of conveyance, the density of the pattern lines and the like, and the relation between the difference Δd in the line width and the value of correction ΔW has similar localism. In order to absorb the localism, the surface of the circuit board is divided into a plurality of regions and the relation between the difference Δd in the line width and the value of correction ΔW for correcting the actual line width to nullify the difference Δd is obtained and stored by said region so that most suitable correction for the region can be made. As the surface of the circuit board is more finely divided, adjustment can be more suitable to difference by the region.

The amount by which the line width is corrected can be obtained by the use of the above relation on the basis of the result of comparison 202 (on the basis of the difference between the width of the line forming the pattern represented by the image information 200 and that represented by the target etched pattern 201 in the case where the relation between the difference in the line width and the value of correction for correcting the line width has been obtained) obtained by the line width comparison means 42. For example, when the difference between the line width represented by the image information 200 and that represented by the target etched pattern 201 is d1 in a certain region D1, the line width in the whole of the region D1 is thinned by the amount corresponding to the value of correction W1 by the use of the value of correction W1 at that time (FIG. 7).

All the lines in the same region may be corrected in the same way (that is, all the widths of the lines in the same region may be corrected on the basis of the above relation stored for each of the regions D1, D2, D3 and D4 in FIG. 4). However, in the case where the difference obtained by the line width comparison means 42 differs by the place in the same region (e.g., when the difference obtained by the line width comparison means 42 is d1 in a position P1 (X1, Y1) in the region D1 and d2 in a position P2 (X2, Y2) in the region D1), the line widths represented by the processing pattern data 100 for the lines in the vicinity of the position P1 may be corrected on the basis of the value of correction W1 corresponding to the difference d1 while the line widths represented by the processing pattern data 100 for the lines in the vicinity of the position P2 may be corrected on the basis of the value of correction W2 corresponding to the difference d2. (The relation stored for the region D1 is such as shown in FIG. 7, which is a representative relation in the region.)

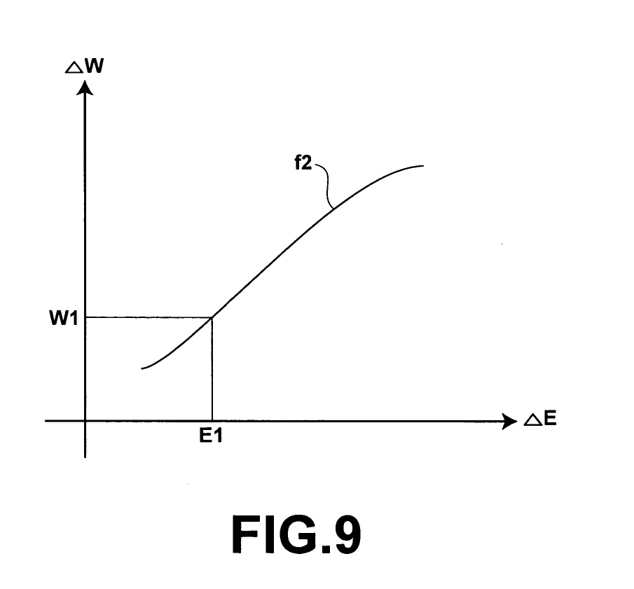

The line width of the etched pattern is adjusted by directly correcting the line width represented by the processing pattern data 100 in the above description. However, the width of the line forming the etched pattern may be adjusted by adjusting exposure according to the processing pattern data 100. In order to adjust the width of the line forming the etched pattern by changing the exposure, it is necessary to store how much the width of the line forming the etched pattern changes with change of the exposure. The value of correction ΔW of the width of the line forming the pattern and the value of correction of the exposure ΔE for correcting the line width by ΔW have relation, for instance, shown in FIG. 9 and expressed by the following formula (2).
ΔW=f2(ΔE) (2)

This relation is also stored on the basis of the empirical knowledge, a result of actual production or the like as the aforesaid formula (1), and since having also a localism, it is preferred that this relation is stored by the region.

When the width of the line forming the etched pattern is to be adjusted by adjusting the exposure, the value of correction W1 for correcting the line width is obtained according to formula (1) on the basis of the result of comparison 202 (the difference d1 in the line width) obtained by the line width comparison means 42, and then a value of correction E1 for correcting the exposure is obtained according to formula (2) on the basis of the value of correction W1 (FIG. 9). Then, the exposure to be transferred to the exposure control system 44 is corrected on the basis of the value of correction E1 thus obtained.

As in adjusting the line width represented by the target etched pattern, it is preferred when the width of the line forming the etched pattern is to be adjusted by adjusting the exposure that the area of the circuit board is divided into a plurality of regions while the target etched pattern 201 is divided into a plurality of regions so that the plurality of regions into which the target etched pattern 201 is divided corresponds to the plurality of regions into which the area of the circuit board is divided, and the comparison is made for each of the corresponding regions. All the lines in the same region may be corrected in the same way or the correction may differ depending on the position in the region (e.g., the aforesaid position P1 or P2).

As can be understood from the description above, when the result of comparison 202 by the line width comparison means 42 is not smaller than a predetermined value, the resist on the copper foil of the next circuit board is exposed to light on the basis of the adjusted exposure or the adjusted line width represented by the processing pattern data 100 (step S102).

After the resist is exposed to light, the unnecessary part of the resist is removed and a resist pattern is formed on the upper surface of the copper foil (step S103). Then, the copper foil bearing thereon the resist pattern thus formed is etched by the etching system 6 and an etched pattern is formed (step S104). The circuit board bearing thereon the etched pattern thus formed is scanned by the image recognition system 60 again (step S105) and the image information 200 obtained is transferred to the exposure system 4. Then, on the basis of the result of comparison by the line width comparison means 42 (step S106), when the difference between the line width represented by the image information 200 and that represented by the target etched pattern 201 is smaller than a predetermined value (step S107-YES), the next circuit board is processed by the use of the processing pattern data 100 as it is, whereas when the difference between the line width represented by the image information 200 and that represented by the target etched pattern 201 is not smaller than the predetermined value (step S107-NO), the next circuit board is processed by the use of the corrected exposure or the corrected processing pattern data (step S108).

Though, in the embodiment described above, the adjustment means 43 carries out the adjustment when the difference between the line width represented by the image information 200 and that represented by the target etched pattern 201 is not smaller than a predetermined value, the adjustment may be carried out even if the difference is very small.

By thus adjusting the exposure or the line width, the etched pattern can be constantly produced at the same accuracy.

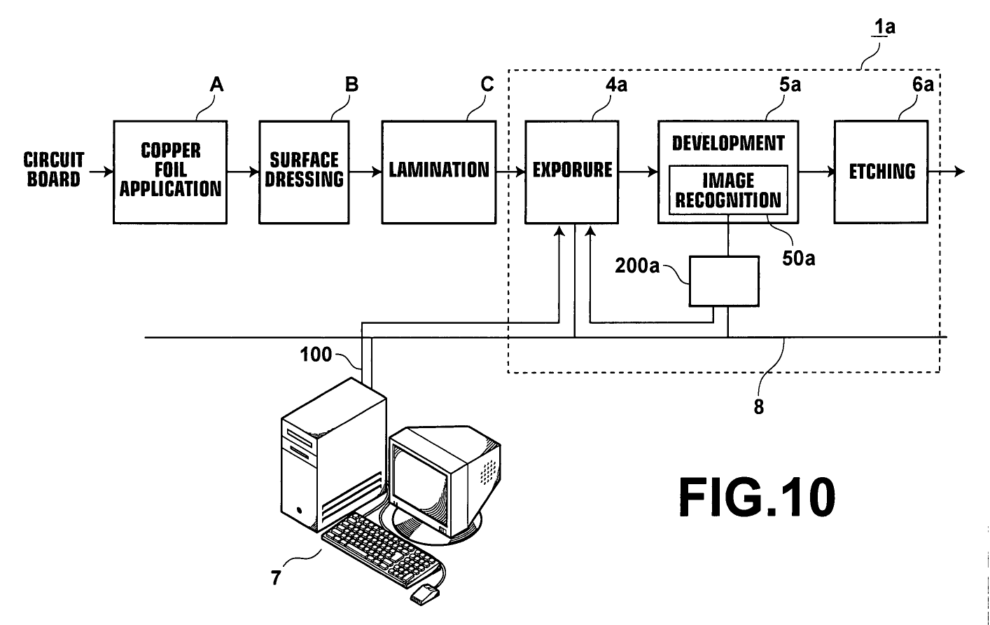

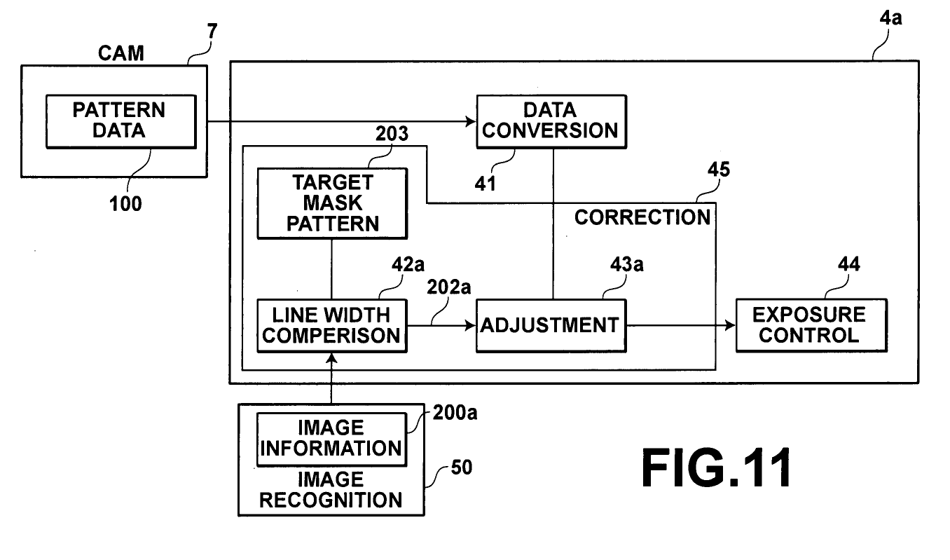

A pattern production system 1a in accordance with a second embodiment of the present invention, where the line width is adjusted by scanning a developed resist pattern, will be described with reference to FIGS. 10 and 11, hereinbelow. In FIGS. 10 and 11, the elements analogous to those of the aforesaid first embodiment are given the same reference numerals and will not be described in detail here. Only the difference from the first embodiment will be described.

The pattern production system 1a of this embodiment comprises an exposure system 4a, a developing system 5a and an etching system 6a.

In this embodiment, an image recognition system 50 is provided in the developing system 5a in place of the etching system 6a. The image recognition system 50 scans a resist pattern obtained by developing the exposed resist to get image information 200a on the resist pattern, and is connected to the exposure system 4a byway of a network 8 to send the obtained image information 200a to the exposure system 4a.

As shown in FIG. 11, the exposure system 4a is provided with a line width comparison means (difference information obtainment unit) 42a which compares the line width represented by the image information 200a recognized by the image recognition system 50 after development with that represented by the target resist pattern 203, which is a target of the resist pattern to be formed after development, and obtains the result of comparison (difference information) 202a, an adjustment means 43a which adjusts the processing pattern data 100 and/or the exposure so that the developed resist pattern approximates the target resist pattern 203 and an exposure control system 44 which exposes the resist to light according to the processing pattern data 100.

The image recognition system 50 is substantially the same as the image recognition system 60 in the first embodiment, and is provided in the developing system 5a to obtain the image information 200a of the actually developed resist pattern.

The target resist pattern 203 is data which is obtained by simulating a resist pattern having a target line width by a CAM or the like and has been stored as the target resist pattern 203.

The adjustment means 43a stores the relation between the value of correction for correcting the line width represented by the processing pattern data 100 and the result of comparison 202a and/or the relation between the value of correction for correcting the exposure and the result of comparison 202a, and makes adjustment substantially the same as in the first embodiment on the basis of the result of comparison 202a of the image information 200a and the target resist pattern 203, obtained by the line width comparison means 42a. The relation between the value of correction for correcting the line width represented by the processing pattern data 100 and the result of comparison 202a and the relation between the value of correction for correcting the exposure and the result of comparison 202a have been stored on the basis of empirical knowledge, a result of actual production or the like as in the first embodiment, and the exposure or the line width represented by the processing pattern data 100 is adjusted on the basis of the relation.

With this arrangement, in the second embodiment, the line width designated by the processing pattern data 100 or the exposure is adjusted from time to time on the basis of the result of comparison 202a of the line width represented by the image information 200a obtained by the image recognition system 50 after development and the width of the line forming the pattern of the target resist pattern 203 so that the resist pattern is finished after development in the line width designated by the target resist pattern 203.

As can be understood from the description above, it is possible in the second embodiment to form the resist patterns at the same accuracy after development.

Though, in the embodiments described above, the line width represented by the processing pattern data and/or the exposure is controlled on the basis of whether the actual etched pattern or the actual developed resist pattern is formed in a target accuracy, more adequate adjustment can be made by providing both the etching system and the developing system with an image recognition system and making an adjustment on the line width represented by the processing pattern data on the basis of one of the result of comparison of the etched pattern after etching with the target etched pattern and the result of comparison of the developed resist pattern with the target resist pattern, which is larger in the line width difference. The line width represented by the processing pattern data may be adjusted taking into account both the results of comparison.

Further, though, in the embodiments described above, when the line width represented by the etched pattern after etching is compared with that represented by the target etched pattern or when the width of the line forming the resist pattern after development is compared with that represented by the target resist pattern, the circuit board is divided into a plurality of regions and the relation between the value of correction for correcting the line width designated by the processing pattern data and the result of comparison is stored by the region, and the processing pattern data may be adjusted by the region on the basis of the result of comparison for each of the regions.

Further, though, in the embodiments described above, the circuit board is divided into a plurality of regions and the comparison is made for each of the regions, only a single relation between the value of correction and the result of comparison may be stored for the whole of the circuit board and the processing pattern data may be adjusted without dividing the circuit board into a plurality of regions in the case where the localism is not severe.

In each of the aforementioned embodiments, an object for judging an error in the pattern is not limited to the line width. The object for judging the error in the pattern may be a shape of the pattern, including the line width. Specifically, the exposure and the processing pattern data may be corrected on the basis of the difference between the shape of the pattern, which is the judgment object, and the shape of the pattern obtained as a result of development or etching.

A pattern production system in accordance with a third embodiment of the present invention will be described, hereinbelow.

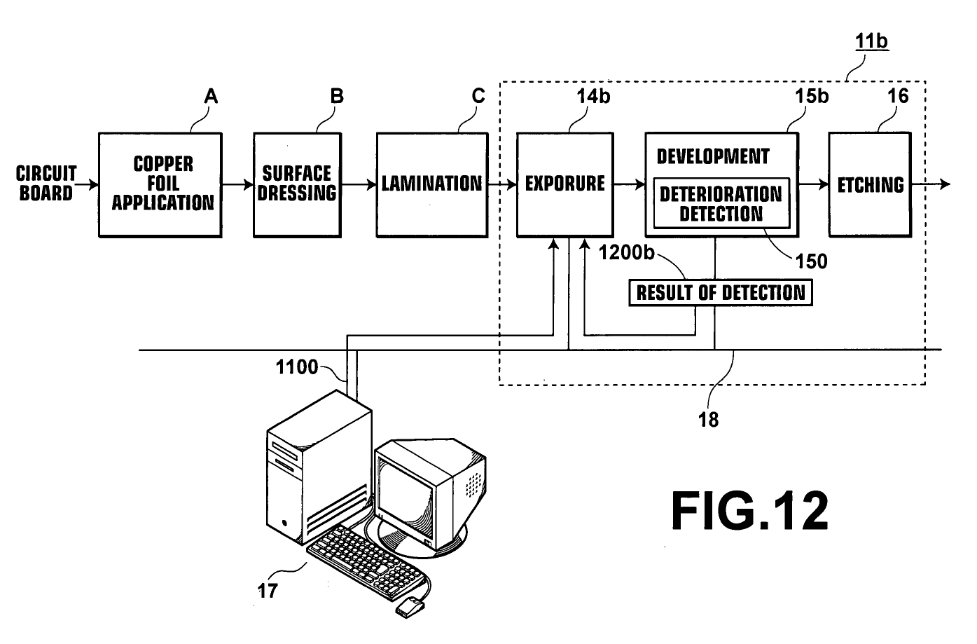

FIG. 12 is a block diagram showing a pattern production system 11 in accordance with the third embodiment of the present invention. Production of a circuit pattern (an etched pattern) by the pattern production system 11 will be described, hereinbelow. First, copper foil which is a circuit formation material is applied to a substrate in copper foil applying step A. The upper surface of the copper foil is dressed by mechanical polishing, chemical polishing or the like in surface dressing step B. Then resist (resist material) is laminated on the dressed upper surface of the copper foil in lamination step C. Thereafter, by the pattern production system 11 according to the present invention, a desired etched pattern is formed by exposing to light the resist on the circuit board, developing the exposed resist to form a resist pattern and etching the copper foil on the substrate, on which the resist pattern is formed, to form an etched pattern.

The pattern production system 11 comprises a direct drawing exposure system (exposure means) 14 which exposes to light the resist laminated on the copper foil, a developing system (developing means) 15 which develops the exposed resist to form a resist pattern and an etching system (etching means) 16 which etches the copper foil on the substrate, on which the resist pattern is formed, to form an etched pattern.

The developing system 15 is provided with a deterioration detecting means 150 which detects deterioration of the developer, and the deterioration detecting means 150 is connected to the exposure system 14 by way of a network 18 so that the result of detection (difference information) 1200 is sent from the deterioration detecting means 150 to the exposure system 14.

The deterioration detecting means 150 may comprise a measuring system (measuring means), which measures the amount of resist dissolved in the developer, provided in the developing system 5 and the result of detection 1200 which represents deterioration of the developer is obtained on the basis of the result of measurement by the measuring system. The measuring system may be, for instance, an automatic analyzer or a liquid control system which measures on the basis of the value of pH or by neutralization titration.

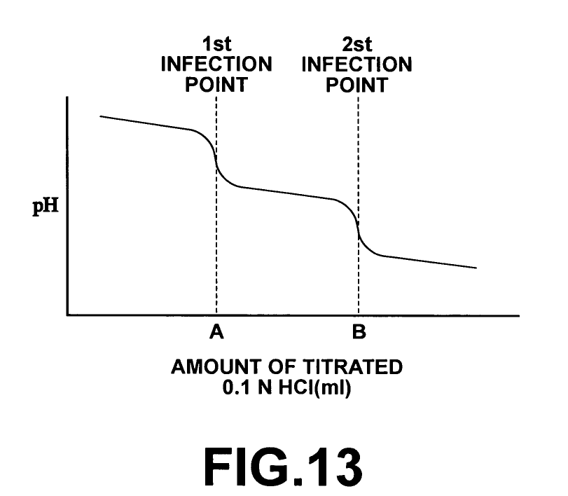

For example, when the amount of resist dissolved in the developer is to be measured by neutralization titration, a part of the developer (e.g., sodium carbonate aqueous solution) used in the developing system 15 is sampled, and hydrochloric acid is titrated in the sampled developer, whereby change in the value of pH is measured and the amount of resist dissolved in the developer can be calculated on the basis of the change in the value of pH. When the value of pH is measured while titrating hydrochloric acid (HCl) in the sampled developer, the measured pH value changes along a curve, for instance, shown in FIG. 13, versus the amount of titrated HCl, and the amount S of resist dissolved in the developer can be known on the basis of the amounts (A and B ml) of titrated HCl at first and second inflection points. That is,
S=k×(B−2A)/C
wherein C represents the sampled amount of the developer and k represents a conversion coefficient to the amount of resist dissolved in the developer.

The deterioration of the developer is detected on the basis of the amount of resist resolved S obtained by the measurement.

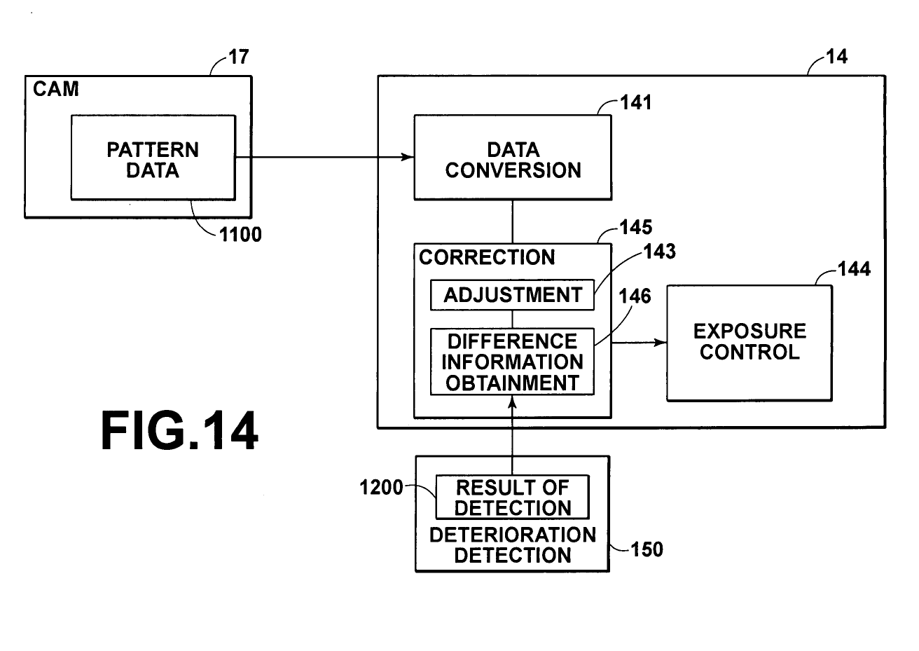

As shown in FIG. 14, the exposure system 14 comprises a data conversion means 141 which converts the processing pattern data 1100 input from the CAM 17 to data of a format suitable for processing, a correction unit 145 which corrects processing pattern data and exposure at the exposure system to produce a finished circuit pattern in conformity with the design, and an exposure control means (including therein the light source for exposure) 144 which exposes the resist to light according to processing pattern data 1100. The correction unit 145 includes an adjustment means 143 which adjusts the processing pattern data 1100 and the exposure by obtaining the result of detection 1200 by the deterioration detecting means 150 at the difference information obtainment unit 146. Hereinafter, a case of providing the correction unit 145 in the exposure system 14 will be described in this embodiment. However, a correction system (correction unit) including the correction unit 145 may be provided in another computer and connected to the exposure system 14.

As the exposure system 14, a direct drawing system, which directly forms an image on the resist by the use of, for instance, a laser beam, is employed. For example, a laser direct drawing system 40 shown in FIG. 3 maybe used. The laser direct drawing system 40, as shown in FIG. 3, is arranged to split a laser beam LB emitted from a laser into a plurality of drawing beam bundles L by way of a beam splitter and/or a beam separator and to cause the split beam bundles L to reach a drawing table T as a drawing beam bundle LL where the split beam bundles L are linearly arranged. The laser direct drawing system 40 causes the drawing bundle LL to scan a circuit board S, set on the drawing table T, in the main scanning direction (the direction of arrow Y) and in the sub-scanning direction (the direction of arrow X) to form an image by dots on the circuit board S. The laser direct drawing system 40 is disclosed in detail, for instance, in Japanese Unexamined Patent Publication Nos. 7(1995)-15993 and 9(1997)-323180. Alternatively, a spatial light modulation device such as an LCD (Liquid Crystal Device) and a DMD (Digital micro-mirror Device) may be used as the direct drawing exposure system.

When a circuit pattern is drawn on the resist coated on the copper foil of the circuit board with the laser drawing system 40 which draws an image by dots by splitting a laser beam into a plurality of drawing beam bundles, the processing pattern data 1100 converted to raster data is used as drawing data, and the exposure control means 144 selectively exposes the resist on the basis of the drawing data. Though the resist is normally exposed on the basis of standard exposure set in the exposure system, exposure can be adjusted as desired. In order to adjust exposure, though exposure obtained by the adjustment means 143 may be transferred to the exposure control means 144 as information separate from the drawing data, when each of the pixels of the drawing data is expressed in a multi-value, the exposure obtained by the adjustment means 143 can be transferred to the exposure control means 144 by converting the drawing data to multi-valued data corresponding to the exposure obtained by the adjustment means. For instance, a pixel (a dot) is expressed in 255 gradations and as the value decreases, the exposure is reduced with 255 representing a maximum exposure. The exposure control means 144 exposes the resist at an exposure corresponding to the gradation on the basis of the multi-valued (gradation) drawing data.

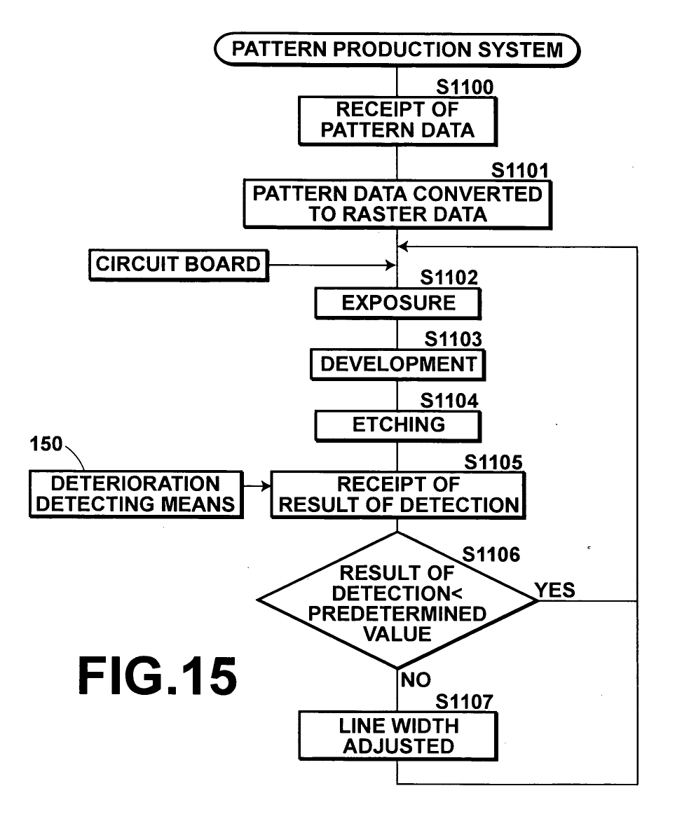

Repeated production of the same circuit pattern by the use of the pattern production system 11 of this embodiment will be described with reference to the flow chart shown in FIG. 15, hereinbelow.

The exposure system 14 receives the processing pattern data 1100 from the CAM 7 to produce a predetermined circuit pattern (step S1100). The exposure system 14 converts the processing pattern data 1100 in a vector data format such as of Gerber data into processing pattern data (drawing data) in a raster data format by the data conversion means 141 (step S1101) and exposes to light the resist on the copper foil by the exposure control means 144 on the basis of the processing pattern data in a raster data format (step S1102).

After exposure to light of the resist coated on the copper foil on the substrate, the developing system 15 develops the exposed resist (in the case of positive resist, the exposed part is removed, whereas in the case of negative resist, the unexposed part is removed) to form a resist pattern on the upper surface of the copper foil (step S1103). Then, the etching system 6 etches the copper foil on the substrate, bearing thereon the resist pattern, thereby forming an etched pattern (step S1104).

The developer used in the developing system 15 is sampled at predetermined intervals and the amount of resist dissolved therein is measured by the deterioration detecting means 150. Deterioration of the developer is detected on the basis of the result of the measurement, and the result of detection 1200 is transferred from time to time to the exposure system 14 by way of the network 18.

When development is repeated in the developing system 15 by the use of the same developer, the amount of resist dissolved in the developer increases, and the resist comes to be hard to develop. Accordingly, the amount of resist developed by the developer is reduced, which results in a thinner line width of the resist pattern. When the width of the line forming the resist pattern is thinner, the width of the line forming the etched pattern by the use of the resist pattern becomes thinner and comes not to conform to the line width represented by the target etched pattern.

In order to finish the resist pattern in a desired line width, the exposure system 14 receives the result of detection 1200 (step S1105). When the result of detection 1200 thus obtained (that is, the amount of resist dissolved in the developer) is smaller than a predetermined value (step S1106-YES), the next circuit board may be processed by the use of the processing pattern data 1100 as it is, whereas when the amount of resist dissolved in the developer is not smaller than the predetermined value (step S1106-NO), the processing pattern data 1100 must be corrected.

The adjustment means 143 adjusts the line width designated by the processing pattern data 1100 on the basis of the amount of resist dissolved in the developer so that the width of the line forming the etched pattern becomes equal to the target line width (the line width of the target etched pattern) (step S1107).

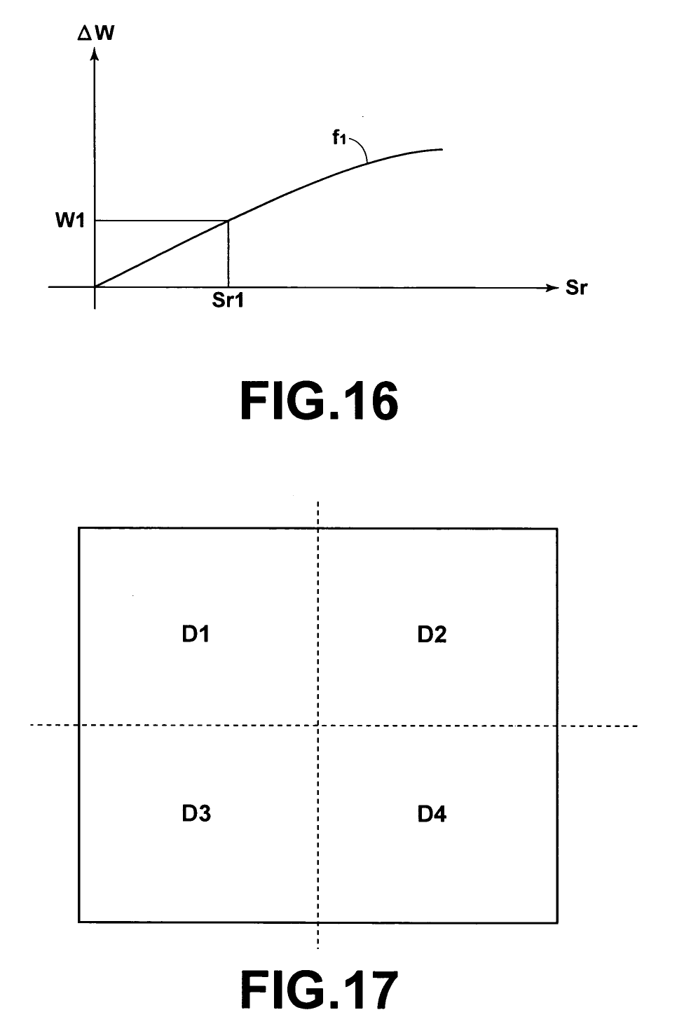

The amount of resist D dissolved in the developer has relation with the value of correction ΔW, for correcting the line width represented by the processing pattern data 1100 so that the width of the line forming the etched pattern becomes equal to the target line width, which is, for instance, shown in FIG. 16 and is represented by the following formula (3):
ΔW=f1(Sr) (3),
wherein Sr represents the amount of resist dissolved in the developer. This relation is stored in the exposure system 14 on the basis of the empirical knowledge, a result of actual production or the like and the adjustment means 143 carries out the adjustment of the line width on the basis of the stored relation.

Localism that the width of the line of the formed pattern differs by the place on the circuit board can be generated due to the circulation of the developer, the shower pressure, the direction of conveyance, the density of the pattern lines and the like, and the relation between the amount of resist D dissolved in the developer and the value of correction ΔW has similar localism. In order to absorb the localism, the surface of the circuit board, which is to be set on the exposure system, the developing system and the etching system sequentially for processing, is divided into a plurality of regions (e.g., D1, D2, D3 and D4 in FIG. 17) and the relation between the amount of resist D dissolved in the developer and the value of correction ΔW is stored by said region so that most suitable correction for the region can be made. As the surface of the circuit board is more finely divided, adjustment can be more suitable to difference by the region.

In the exposure system 14, the adjustment means 143 determines the amount by which the line width is corrected by the use of the above relation on the basis of the amount of resist dissolved in the developer, received from the measuring system 151. For example, when the amount of resist dissolved in the developer is Sr1, the adjustment means adjusts the line width designated by the processing pattern data 1100 by the value of correction W1 corresponding to Sr1 (FIG. 16).

When the aforesaid relation is stored by for each of the regions D1, D2, D3 or D4 shown in FIG. 17, the processing pattern data 1100 is also divided into a plurality of regions to correspond to the regions on the circuit board. Then, the width of the line forming the pattern represented by the processing pattern data 1100 is corrected for each of the regions.

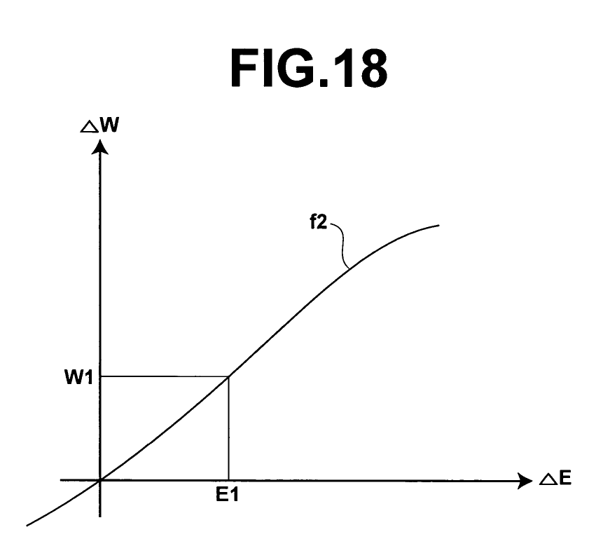

The width of the line forming the etched pattern is adjusted by correcting the line width represented by the processing pattern data 1100 in the above description. However, the width of the line forming the etched pattern may be adjusted by adjusting exposure according to the processing pattern data 1100. In order to adjust the width of the line forming the etched pattern by changing the exposure, it is necessary to store how much the width of the line forming the etched pattern changes with change of the exposure. The value of correction ΔW of the line width and the value of correction of the exposure ΔE for correcting the line width by ΔW have relation, for instance, shown in FIG. 18 and expressed by the following formula (4).
ΔW=f2(ΔE) (4)

This relation is also stored in the exposure system 14 on the basis of the empirical knowledge, a result of actual production or the like as the aforesaid formula (1), and since having also a localism by the position on the circuit board, it is preferred that this relation is stored by the region.

When the width of the line forming the etched pattern is to be adjusted by adjusting the exposure, the value of correction W1 for correcting the line width is obtained according to formula (3) on the basis of the result of detection 1200 (the amount of resist dissolved in the developer) by the adjustment means 143, and then a value of correction E1 for correcting the exposure is obtained according to formula (4) on the basis of the value of correction W1 (FIG. 18). Then, the exposure to be transferred to the exposure control system 144 is corrected on the basis of the value of correction E1 thus obtained.

As in adjusting the line width, it is preferred when the width of the line forming the etched pattern is to be adjusted by adjusting the exposure that the area of the circuit board is divided into a plurality of regions while the processing pattern data 1100 is divided into a plurality of regions so that the plurality of regions into which the processing pattern data 1100 is divided correspond to the plurality of regions into which the area of the circuit board is divided, and the correction and adjustment are made for each of the corresponding regions.

As can be understood from the description above, when the amount of resist dissolved in the developer measured by the measuring system is not smaller than a predetermined value, the resist on the copper foil of the next circuit board is exposed to light on the basis of the adjusted exposure or the adjusted line width represented by the processing pattern data 1100 (step S1102).

After the resist is exposed to light, the unnecessary part of the resist is removed and a resist pattern is formed on the upper surface of the copper foil (step S1103). Then, the copper foil bearing thereon the resist pattern thus formed is etched by the etching system 16 and an etched pattern is formed (step S1104).

Then when the amount of resist dissolved in the developer measured by the measuring system 151 is smaller than a predetermined value (step S1106-YES), the next circuit board is processed at the same exposure by the use of the processing pattern data 1100 as it is without adjustment, whereas when the amount of resist dissolved in the developer measured by the measuring system is not smaller than the predetermined value (step S1106-NO), the next circuit board is processed by the use of the corrected processing pattern data (step S1107).

Though, in the embodiment described above, the adjustment means 143 carries out the adjustment when the difference is not smaller than a predetermined value, the adjustment may be carried out even if the difference is very small.

Though, in the embodiment described above, the line width represented by the processing pattern data is corrected on the basis of the measured amount of resist dissolved in the developer, the line width represented by the processing pattern data may be corrected on the basis of the measured value of pH of the developer sampled at the measuring system. In this case, a relation between the value of pH of the developer and the value of correction of the line width represented by the processing pattern data is obtained, and stored in advance in the exposure system, and the correction is carried out on the basis of the relation.

As described above, by measuring the amount of resist dissolved in the developer or the value of pH of the developer to detect deterioration of the developer, the exposure or the line width represented by the processing pattern data can be adjusted according to the amount of resist dissolved in the developer so that the pattern is etched in a desired line width.

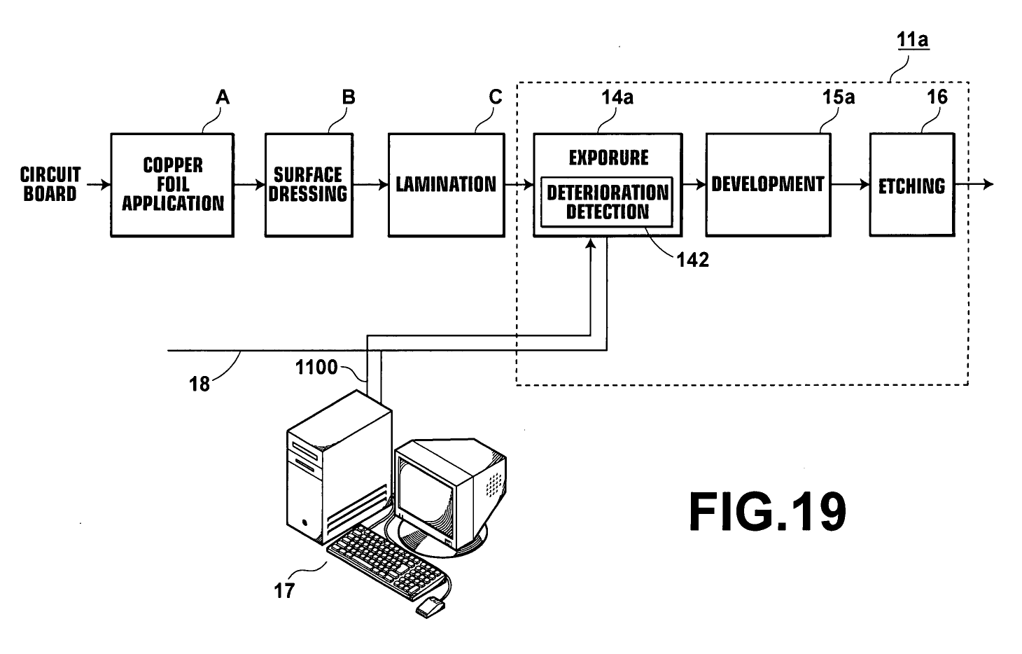

A pattern production system 11a in accordance with a fourth embodiment of the present invention, where the deterioration of the developer is detected on the basis of the total processed area of the resist developed by the developer, will be described, hereinbelow. FIG. 19 is a block diagram showing a pattern production system 11a in accordance with the fourth embodiment of the present invention. In FIG. 19, the elements analogous to those of the aforesaid third embodiment are given the same reference numerals and will not be described in detail here. Only the difference from the third embodiment will be described.

The pattern production system 11a of this embodiment comprises an exposure system 14a, a developing system 15a and an etching system 16.

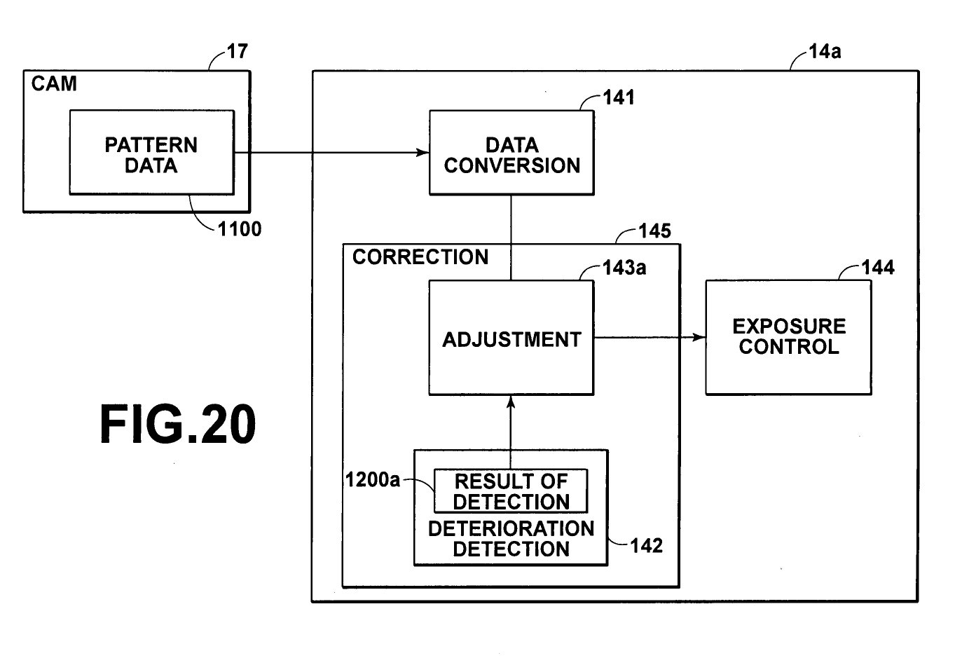

In this embodiment, a deterioration detecting means 142 is provided in the exposure system 14a in place of the developing system 15a. As shown in FIG. 20, the exposure system 14a is provided with a data conversion means 141 which converts the processing pattern data 1100 input from the CAM 17 to data of a format suitable for processing, an adjustment means 143a which adjusts the processing pattern data 1100 on the basis of the result of detection (difference information) 1200a obtained by the deterioration detecting means (difference information obtainment unit) 142 and an exposure control means 144 which exposes the resist to light according to the processing pattern data 1100.

The deterioration detecting means 142 totals the area of the resist exposed by the exposure control means 144 and obtains the total developed resist area developed by the developer on the basis of the total exposed resist area. Then, the deterioration detecting means 142 obtains the amount of resist dissolved in the developer on the basis of the total developed resist area. In the case of positive resist, the exposed part is dissolved in the developer, whereas in the case of negative resist, the unexposed part is dissolved in the developer. In the case of the former, the total exposed area is the total developed resist area, whereas in the case of the latter, the total of the area over which the resist is coated minus the total exposed area is the total developed resist area.

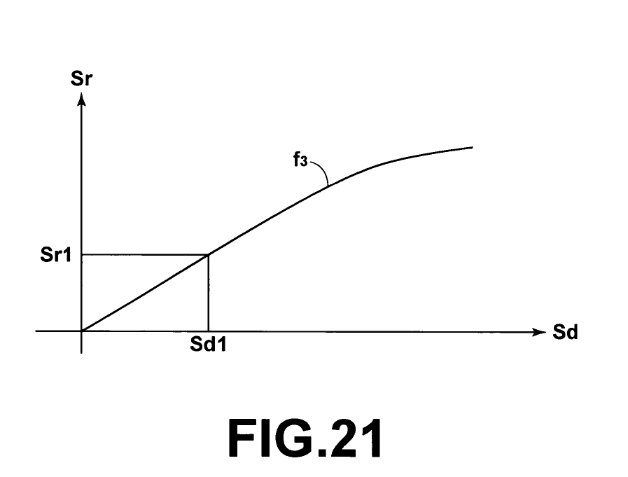

The amount of resist Sr dissolved in the developer has relation with the total developed resist area Sd, which is, for instance, shown in FIG. 21 and is represented by the following formula (5):
Sr=f3(Sd) (5).
This relation has been stored in the exposure system 14a on the basis of the empirical knowledge, a result of actual production or the like.

The adjustment means 143a obtains the amount Sr1 of resist dissolved in the developer corresponding to the total developed resist area Sd1 according to formula (5) and the value of correction ΔW corresponding to the amount Sr1 of resist dissolved in the developer according to formula (3), and corrects the line width represented by the processing pattern data 1100 on the basis of the value of correction ΔW.

It is preferred as in the third embodiment that the surface of the circuit board is divided into a plurality of regions and the relation between the amount of resist dissolved in the developer and the value of correction ΔW is stored by said region so that the most suitable correction for the region can be made.

Further, as in the third embodiment, how much the width of the line forming the etched pattern changes with change of the exposure may be stored in the exposure system 14a, and the line width in which the etched pattern is finished may be adjusted by correcting the exposure to be transferred to the exposure control unit 144. Since having also a localism depending on the production system, it is preferred that this relation is stored by the region.

Further, it is preferred that the developing system and the exposure system be connected with each other by way of a network and the total developed resist area be cleared each time the developer is changed by receiving information from the exposure system that the developer has been changed. Otherwise, the total developed resist area may be manually cleared from, for instance, a control panel of the exposure system.

By detecting deterioration of the developer from the total developed resist area and adjusting the exposure or the line width represented by the processing pattern data according to the total developed resist area so that the developed resist pattern is finished in a desired line width, the etched pattern can be constantly uniformly finished.

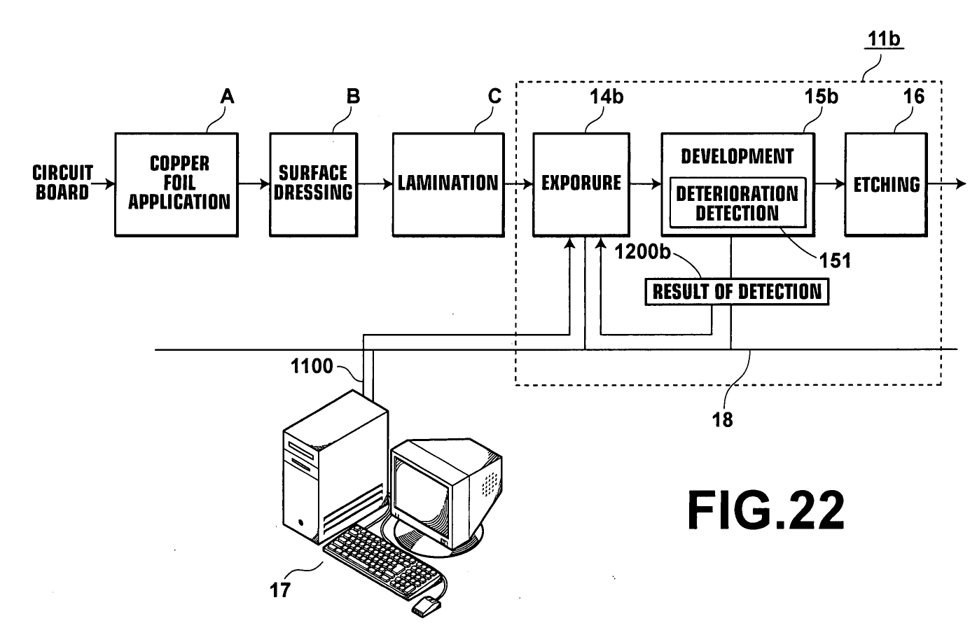

A pattern production system 11b in accordance with a fifth embodiment of the present invention, where the deterioration of the developer is detected on the basis of the total processed area of the resist developed by the developer, will be described, hereinbelow. FIG. 22 is a block diagram showing a pattern production system 11b in accordance with a fifth embodiment of the present invention. In FIG. 22, the elements analogous to those of the aforesaid third embodiment are given the same reference numerals and will not be described in detail here. Only the difference from the third embodiment will be described.

The pattern production system 11b of this embodiment comprises an exposure system 14b, a developing system 15b and an etching system 16.

In this embodiment, the developing system 15b is provided with a deterioration detecting means 151 which detects deterioration of the developer. The deterioration detecting means 151 is connected to the exposure system 14b by way of a network 18 and the result of detection 1200b is transferred from the deterioration detecting means 151 to the exposure system 14b.

The developing system 15b can count the number of circuit boards to be developed and the deterioration detecting means 151 calculates the total developed resist area, the area of the resist developed by the developer, from the developed resist area per one circuit board and the number of circuit boards developed, and outputs it as the result of detection (difference information) 1200b.

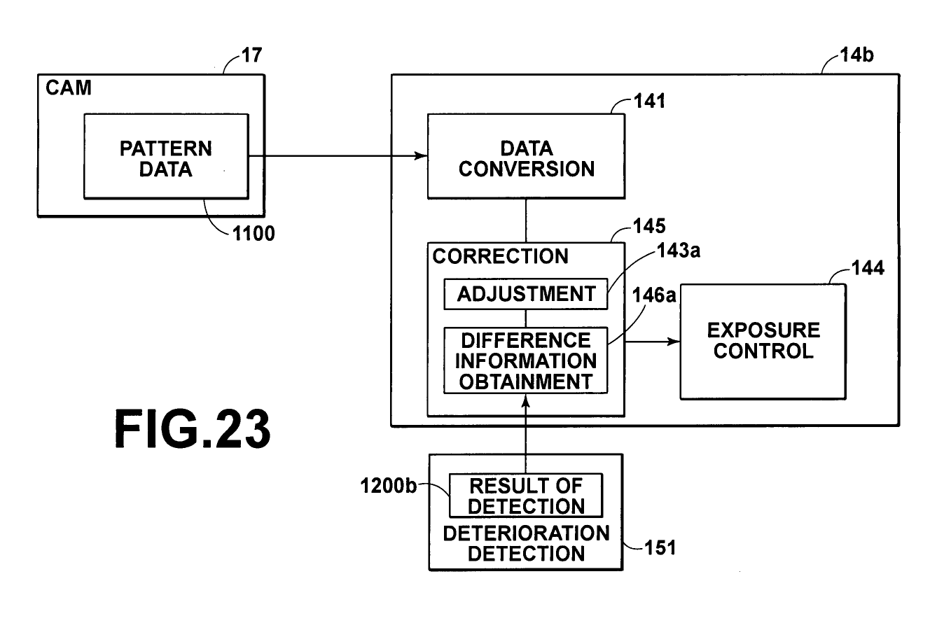

As shown in FIG. 23, the exposure system 14b is provided with a data conversion means 141 which converts the processing pattern data 1100 input from the CAM 17 to data of a format suitable for processing, an adjustment means 143a which adjusts the processing pattern data 1100 on the basis of the total developed resist area obtained by the deterioration detecting unit 146a and an exposure control system 144 which exposes the resist to light according to the processing pattern data 1100.

The relation between the amount of resist dissolved in the developer and the total developed resist area is obtained on the basis of the empirical knowledge, a result of actual production or the like and stored in the exposure system 14b as in the fourth embodiment. The adjustment means 143a obtains the amount of resist dissolved in the developer corresponding to the total developed resist area received from the deterioration detecting means 151 and the value of correction corresponding to the amount of resist dissolved in the developer, and corrects the line width represented by the processing pattern data 1100 on the basis of the value of correction as in the fourth embodiment.

It is preferred as in the third and fourth embodiments that the surface of the circuit board is divided into a plurality of regions and the relation between the amount of resist dissolved in the developer and the value of correction is stored by said region so that the most suitable correction for the region can be made.

Further, as in the third and fourth embodiments, how much the width of the line forming the etched pattern changes with change of the exposure may be stored in the exposure system 14b, and the line width in which the etched pattern is finished may be adjusted by correcting the exposure to be transferred to the exposure control unit 144. Since having also a localism depending on the production system, it is preferred that this relation is stored by the region.

Further, it is preferred as in the third embodiment that the developing system and the exposure system be connected with each other by way of a network and the total developed resist area be cleared by receiving information from the exposure system that the developer has been changed each time the developer is changed. Otherwise, the total developed resist area may be manually cleared from, for instance, a control panel of the exposure system.

By detecting deterioration of the developer from the total developed resist area and adjusting the exposure or the line width represented by the processing pattern data according to the total developed resist area so that the etched pattern is finished in a desired line width, the etched pattern can be constantly uniformly finished.

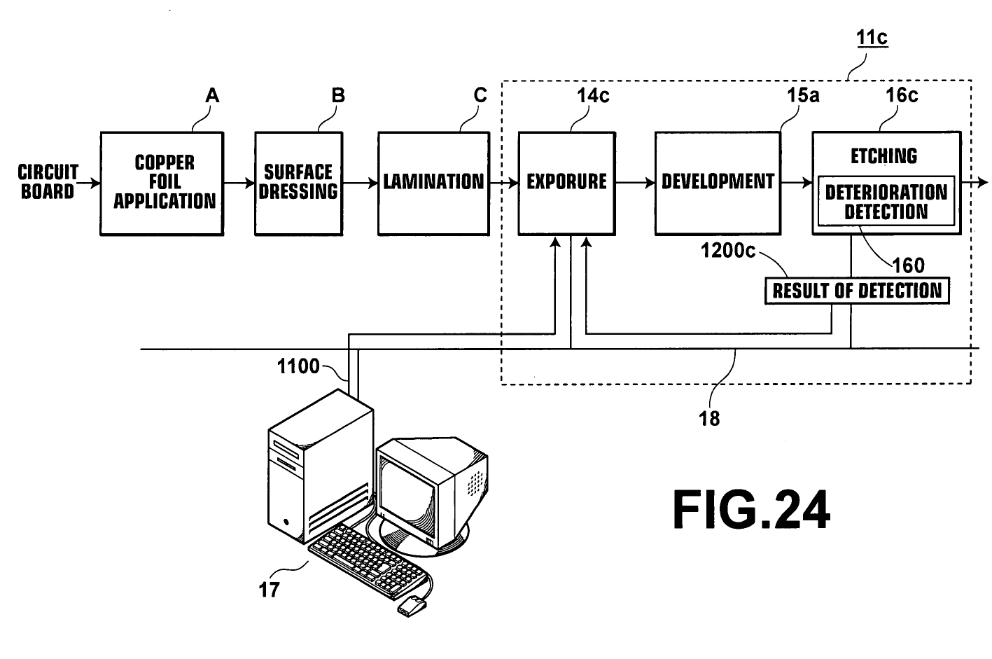

A pattern production system 11c in accordance with a sixth embodiment of the present invention, where the deterioration of the etching liquid is detected and the adjustment is carried out so that the width of the line forming the etched pattern becomes a desired width, will be described, hereinbelow. FIG. 24 is a block diagram showing a pattern production system 11c in accordance with the sixth embodiment of the present invention. In FIG. 24, the elements analogous to those of the aforesaid third embodiment are given the same reference numerals and will not be described in detail here. Only the difference from the third embodiment will be described.

The pattern production system 11c of this embodiment comprises an exposure system 14c, a developing system 15a and an etching system 16c.

In this embodiment, the etching system 16ce is provided with a deterioration detecting means 160 which detects deterioration of the etching liquid. The deterioration detecting means 160 is connected to the exposure system 14c by way of a network 18 and the result of detection 1200c which is a measured value of pH of the sampled etching liquid is transferred from the deterioration detecting means 160 to the exposure system 14c.

The deterioration detecting means 160 may comprise a measuring system (measuring means), which measures the value of pH of the etching liquid, provided in the etching system 16c and the result of detection 1200c which represents deterioration of the etching liquid is obtained on the basis of the result of measurement of the value of pH of the sampled etching liquid by the measuring system.

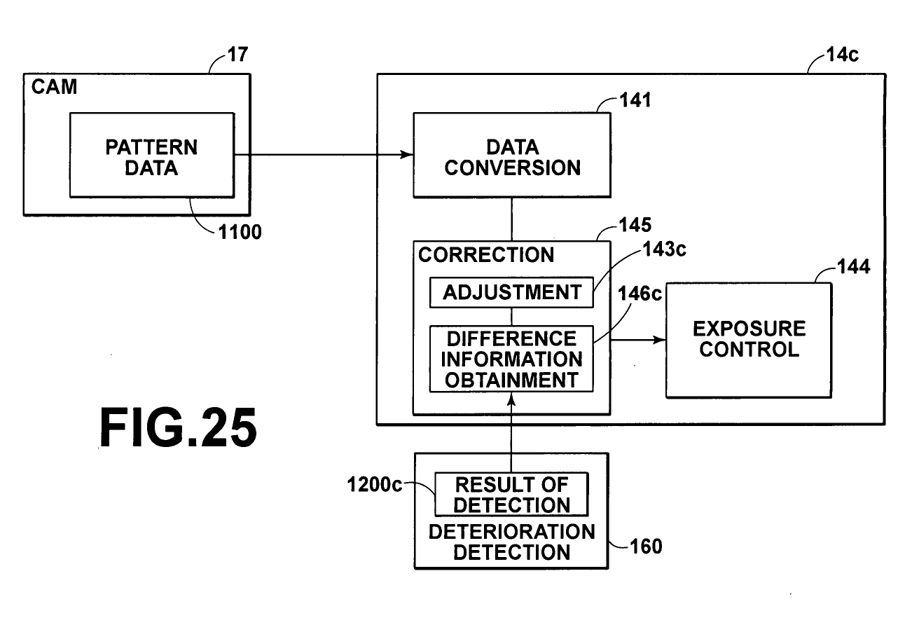

As shown in FIG. 25, the exposure system 14c is provided with a data conversion means 141 which converts the processing pattern data 1100 input from the CAM 17 to data of a format suitable for processing, an adjustment means 43c which adjusts the processing pattern data 1100 on the basis of the value of pH (difference information) of the etching liquid, obtained by the deterioration detecting means 160, from the difference information obtainment means 146c and an exposure control system 144 which exposes the resist to light according to the processing pattern data 1100.

The relation between the value of pH of the etching liquid and the value of correction for correcting the line width represented by the processing pattern data 1100 is obtained on the basis of the empirical knowledge, a result of actual production or the like and stored in the exposure system 14c. The adjustment means 143c corrects the line width represented by the processing pattern data 1100 on the basis of this relation and the value of pH of the etching liquid received from the deterioration detecting means 160 of the etching system 16c.

Localism that the width of the line of the formed pattern differs by the place on the circuit board can be generated due to the circulation of the etching liquid, the shower pressure, the direction of conveyance, the density of the pattern lines and the like, and the relation between the value of pH of the etching liquid and the value of correction has similar localism. Accordingly it is preferred as in the third to fifth embodiments that the surface of the circuit board is divided into a plurality of regions and the relation between the value of pH of the etching liquid and the value of correction for correcting the line width is stored by said region so that the most suitable correction for the region can be made.

Further, as in the third to fifth embodiments, how much the width of the line forming the etched pattern changes with change of the exposure may be stored in the exposure system 14c, and the line width in which the etched pattern is finished may be adjusted by correcting the exposure to be transferred to the exposure control unit 144. Since having also a localism depending on the production system, it is preferred that this relation is stored by the region.

By detecting deterioration of the etching liquid from the value of pH of the etching liquid and adjusting the exposure or the line width represented by the processing pattern data according to the value of pH of the etching liquid so that the etched pattern is finished in a desired line width, the etched pattern can be constantly uniformly finished.

Further, though, in the third to fifth embodiments, deterioration of the developer or the etching liquid is detected and the exposure or the line width represented by the processing pattern data is adjusted on the basis of deterioration of the developer or the etching liquid, deterioration of both the developer and the etching liquid may be detected and the value of correction for adjusting the exposure or the line width represented by the processing pattern data on the basis of deterioration of both the developer and the etching liquid may be empirically obtained and stored.

Further, though, in the embodiments described above, the circuit board is divided into a plurality of regions and the comparison is made for the regions, only a single relation between the value of correction for correcting the line width designated by the processing pattern data and the result of comparison may be stored for the whole of the circuit board and the processing pattern data may be adjusted without dividing the circuit board into a plurality of regions in the case where the localism is not severe.

Further, when the etching system 6 is provided with an image recognition system such as an optical inspection machine (AOI) employing a CCD camera so that image information representing the etched pattern formed by etching the copper foil can be obtained by scanning and the finish of the etched pattern can be checked in the embodiments described above, the finishing accuracy can be visually checked.

As described in detail above, the exposure and the processing pattern data may be adjusted on the basis of the condition of the developer and the condition of the etching liquid which influence the line width, namely the shape of the pattern.

The condition of the developer and the condition of the etching liquid may be detected or predicted on the basis of a number of times of development or etching. The exposure and the processing pattern data may be adjusted on the basis of the number of times of development or etching and a size of a circuit board.

Further, an error in the pattern shape after development or etching may be predicted on the basis of the number of times of exposure. The exposure and the processing pattern data may be adjusted on the basis of the predicted error. In this case, the condition of the developer and the etching liquid may be predicted on the basis of the number of times of exposure.

Further, adjustment of the exposure and the processing pattern data on the basis of the number of times of exposure and adjustment on the basis of the image information of the pattern may be carried alternately. For example, the adjustment on the basis of the image information may be carried out every predetermined number of times of adjustment on the basis of the number of times of exposure. In this case, a switching means for switching the adjustment between the adjustment on the basis of the number of times of exposure and the adjustment on the basis of the image information may be provided in the exposure system.

In each of the aforementioned embodiments, the copper foil was etched. However, the material to be etched is not limited to the copper foil, and may be various metals such as aluminum for forming a reflective film of an LCD display device; metal oxides such as ITO; or semiconductors.

In addition, in the embodiments described above, the amount of exposure and the drawing data are corrected, based on errors and causes thereof of resist patterns and formed patterns. The cause of the errors maybe the time elapsed from the initiation of processes, or the time elapsed from the setting of the developer or etching liquid. Alternatively, the causes of the errors may be data that represents the deteriorated state of the developer or the etching liquid, such as the colors and viscosities thereof.

Further, correction of the exposure amounts and the drawing data may be performed after every cycle of a predetermined number of times that exposure, developing, or etching is performed on the substrate.

Still further, there are cases in which methods for producing a circuit board that does not require etching are applied. However, the drawing data and the exposure amounts may be corrected based on errors and causes thereof in the resist pattern after being developed in these cases as well.

Further, though, in the embodiments described above, the present invention is applied to production of a circuit pattern, the present invention may be applied to production of a color filter, in which a resist or color photosensitive material is coated on the glass plate, in order to suppress fluctuation in the patterns produced after development or etching. For example, the present invention can be applied to production of the color filters for a plasma display, a liquid crystal display, or an organic EL display.

Further, the present invention can be applied to a semiconductor manufacturing system in which resist is coated on a silicon wafer.

As described above in detail, by adjusting the processing pattern data from time to time depending on the deterioration of the etching liquid or the developer, more accurate finish can be maintained.

As described in the above embodiments, the exposure system (or apparatus) comprises:
an exposure unit which exposes to light, by direct drawing on the basis of processing pattern data for forming a target etched pattern through development and etching, resist coated on a material to be etched, on a substrate at a predetermined exposure;
a difference information obtainment unit which obtains difference information including at least one of a difference between a shape of a developed resist pattern and a shape of a target resist pattern, a difference between a shape of an etched pattern and a shape of a target etched pattern, and an element which causes the difference; and
a correction unit which corrects the processing pattern data and/or the predetermined exposure on the basis of the difference information.

A configuration may be adopted wherein the difference information obtainment unit obtains the difference information by comparing image information represented by the resist pattern and a shape of the target resist pattern and/or image information represented by the etched pattern and a shape of the target etched pattern.

A configuration may be adopted wherein the difference information obtainment unit includes a unit for obtaining the image information.

A configuration may be adopted wherein the difference information obtainment unit obtains the difference information on the basis of condition of the developer and/or the etching liquid.

A configuration may be adopted wherein the difference information obtainment unit includes a unit for detecting the condition of the developer and/or the etching liquid.

A configuration may be adopted wherein the difference information obtainment unit includes a unit for detecting on the basis of a number of times of development by the use of the same developer and/or a number of times of etching by the use of the same etching liquid.

A configuration may be adopted wherein the difference information obtainment unit obtains the difference information on the basis of a number of times of development by the use of the same developer and/or a number of times of etching by the use of the same etching liquid.

A configuration may be adopted wherein the difference information obtainment unit includes a unit for obtaining the number of times of development by the use of the same developer and/or the number of times of etching by the use of the same etching liquid on the basis of the number of times of exposure.

A configuration may be adopted wherein the difference information obtainment unit detects the difference information on the basis of a number of times of development by the use of the same developer and/or a number of times of etching by the use of the same etching liquid and a size of the substrate.

A configuration may be adopted wherein the difference information obtainment unit includes a unit for obtaining the number of times of development by the use of the same developer and/or the number of times of etching by the use of the same etching liquid on the basis of the number of times of exposure.

A configuration may be adopted wherein the difference information obtainment unit detects the difference information on the basis of a number of times of development by the use of the same developer and/or a number of times of etching by the use of the same etching liquid and an area on a surface of the substrate, on which development and/or etching is carried out.

A configuration may be adopted wherein the difference information obtainment unit includes a unit for obtaining the number of times of development by the use of the same developer and/or the number of times of etching by the use of the same etching liquid on the basis of the number of times of exposure.

A configuration may be adopted wherein the difference information obtainment unit obtains the difference information on the basis of the number of times of exposure.

A configuration may be adopted wherein the difference information obtainment unit includes a first obtainment unit for obtaining the difference information by comparing the image information of the resist pattern and the shape of the target resist pattern and/or comparing the image information of the etched pattern and the shape of the target etched pattern and a second obtainment unit for obtaining the difference information on the basis of the number of times of exposure and further includes a switching unit for switching the obtainment between the obtainment by the first obtainment unit and the obtainment by the second obtainment unit.

A configuration may be adopted wherein the switching unit switches the obtainment of the difference information between the obtainment by the first obtainment unit and the obtainment by the second obtainment unit every predetermined number of obtainment.

A configuration may be adopted wherein the predetermined number of obtainment is different between each switching direction.

A configuration may be adopted wherein the correction unit carries out the correction for each of the regions formed by dividing a surface of the substrate.

A configuration may be adopted wherein the difference information obtainment unit obtains the difference information regarding a part of a surface of the substrate.

1. A pattern production system comprising an exposure unit which exposes to light, by direct drawing on the basis of processing pattern data for forming a target etched pattern, resist coated on a material to be etched, on a substrate at a predetermined exposure, a developing unit which develops the exposed resist to form a resist pattern, an etching unit which forms an etched pattern by etching the material to be etched, and a correction unit which corrects the processing pattern data and/or the predetermined exposure on the basis of at least one or a combination of a difference between a shape of the resist pattern and a shape of a target resist pattern, a difference between a shape of the etched pattern and a shape of the target etched pattern, and an element which causes the difference.

2. A pattern production system as defined in claim 1, wherein the correction unit includes an image recognition means which scans the etched pattern and obtains image information, a line width comparison means which compares a width of a line forming the pattern represented by the image information and a width of a line forming the pattern of the target etched pattern, and an adjustment means which adjusts at least one of the predetermined exposure and the width of the line forming the pattern designated by the processing pattern data on the basis of the result of comparison by the line width comparison means.

3. A pattern production system as defined in claim 2, wherein said adjustment means stores a relation between a value of correction for correcting the width of the line forming the pattern designated by the processing pattern data and the result of comparison and obtains, on the basis of the relation, the value of correction corresponding to the result of comparison by the line width comparison means, thereby adjusting the width of the line forming the pattern designated by the processing pattern data by the use of the value of correction.

4. A pattern production system as defined in claim 2, wherein the line width comparison means obtains the result of comparison for each of the regions formed by dividing the target etched pattern into a plurality of regions, and the adjustment means stores the relation between the value of correction for correcting the width of the line forming the pattern designated by the processing pattern data and the result of comparison for each of the regions and obtains, on the basis of the relation, the value of correction for each of the regions, corresponding to the result of comparison for each of the regions, obtained by the line width comparison means, thereby adjusting the width of the line forming the pattern designated by the processing pattern data by the use of the value of correction.

5. A pattern production system as defined in claim 2, wherein the adjustment means stores a relation between the value of correction for correcting the predetermined exposure and the result of comparison and obtains, on the basis of the relation, the value of correction of the predetermined exposure corresponding to the result of comparison by the line width comparison means, thereby adjusting the predetermined exposure by the use of the value of correction.

6. A pattern production system as defined in claim 1, wherein the correction unit includes an image recognition means which scans the developed resist pattern and obtains image information, a line width comparison means which compares a width of a line forming the pattern represented by the image information and a width of a line forming the pattern of the target resist pattern, and an adjustment means which adjusts at least one of the predetermined exposure and a width of the line forming the pattern designated by the processing pattern data on the basis of the result of comparison by the line width comparison means.

7. A pattern production system as defined in claim 6, wherein said adjustment means stores a relation between a value of correction for correcting the width of the line forming the pattern designated by the processing pattern data and the result of comparison and obtains, on the basis of the relation, the value of correction corresponding to the result of comparison by the line width comparison means, thereby adjusting the width of the line forming the pattern designated by the processing pattern data by the use of the value of correction.

8. A pattern production system as defined in claim 6, wherein the line width comparison means obtains the result of comparison for each of the regions formed by dividing the target etched pattern into a plurality of regions, and the adjustment means stores the relation between the value of correction for correcting the width of the line forming the pattern designated by the processing pattern data and the result of comparison for each of the regions and obtains, on the basis of the relation, the value of correction for each of the regions, corresponding to the result of comparison for each of the regions, obtained by the line width comparison means, thereby adjusting the width of the line forming the pattern designated by the processing pattern data by the use of the value of correction.

9. A pattern production system as defined in claim 6, wherein the adjustment means stores a relation between the value of correction for correcting the predetermined exposure and the result of comparison and obtains, on the basis of the relation, the value of correction of the predetermined exposure corresponding to the result of comparison by the line width comparison means, thereby adjusting the predetermined exposure by the use of the value of correction.

10. A pattern production system as defined in claim 1, wherein the correction unit includes a deterioration detecting means which detects deterioration of the developer used by the developing unit and an adjustment means which adjusts at least one of the predetermined exposure and the width of the line forming the pattern designated by the processing pattern data on the basis of the result of detection by the deterioration detecting means.

11. A pattern production system as defined in claim 10, wherein the deterioration detecting means includes a measuring means which measures an amount of resist dissolved in the developer used by the developing unit, and detects deterioration of the developer on the basis of the result of measurement by the measuring means.

12. A pattern production system as defined in claim 10, wherein the deterioration detecting means detects deterioration of the developer on the basis of a total processed area of a substrate developed by the developer.

13. A pattern production system as defined in claim 10, wherein the deterioration detecting means comprises a measuring means which measures the pH value of the developer used by the developing unit, and detects deterioration of the developer on the basis of the result of measurement by the measuring means.

14. A pattern production system as defined in claim 10, wherein the adjustment means stores the relation between the value of correction for correcting the width of the line forming the pattern and the deterioration of the developer used by the developing unit, and obtains, on the basis of the relation, the value of correction corresponding to the deterioration according to the result of detection by the deterioration detecting means, thereby adjusting the width of the line forming the pattern designated by the processing pattern data by the use of the value of correction.

15. A pattern production system as defined in claim 10, wherein the adjustment means stores the relation between the value of correction for correcting the width of the line forming the pattern and the deterioration of the developer used by the developing unit for each of the regions formed by dividing a substrate into a plurality of regions, and obtains, on the basis of the relation, the value of correction for each of the regions, corresponding to the deterioration according to the result of detection by the deterioration detecting means, thereby adjusting the width of the line forming the pattern designated by the processing pattern data for each of the regions.

16. A pattern production system as defined in claim 10, wherein the adjustment means stores a relation between the value of correction of the predetermined exposure and the deterioration of the developer used by the developing unit and obtains, on the basis of the relation, the value of correction of the predetermined exposure, corresponding to the deterioration according to the result of detection by the deterioration detecting means, thereby adjusting the predetermined exposure by the use of the value of correction.

17. A pattern production system as defined in claim 1, wherein the correction unit includes a deterioration detecting means which detects deterioration of etching liquid used by the etching means and an adjustment means which adjusts at least one of the predetermined exposure and the width of the line forming the pattern designated by the processing pattern data on the basis of the result of detection by the deterioration detecting means.

18. A pattern production system as defined in claim 17, wherein the deterioration detecting means includes a measuring means which measures the pH value of the etching liquid used by the etching unit, and detects deterioration of the etching liquid on the basis of the result of measurement by the measuring means.

19. A pattern production system as defined in claim 17, wherein the adjustment means stores a relation between the value of correction for correcting the width of the line forming the pattern designated by the processing pattern data and the deterioration of the etching liquid used by the etching unit and obtains, on the basis of the relation, the value of correction corresponding to the result of detection by the deterioration detecting means, thereby adjusting the width of the line forming the pattern designated by the processing pattern data by the use of the value of correction.

20. A pattern production system as defined in claim 17, wherein the adjustment means stores the relation between the value of correction for correcting the width of the line forming the pattern and the deterioration of the etching liquid used by the etching unit for each of the regions formed by dividing the substrate into a plurality of regions, and obtains, on the basis of the relation, the value of correction corresponding to the deterioration according to the result of detection by the deterioration detecting means, thereby adjusting the width of the line forming the pattern designated by the processing pattern data for each of the regions by the use of the value of correction.

21. A pattern production system as defined in claim 17, wherein the adjustment means stores a relation between the value of correction for correcting the predetermined exposure and the deterioration of the etching liquid used by the etching unit and obtains, on the basis of the relation, the value of correction of the predetermined exposure corresponding to the result of detection by the deterioration detecting means, thereby adjusting the predetermined exposure by the use of the value of correction.

22. An exposure method comprising the steps of:
exposing to light, by direct drawing on the basis of processing pattern data for forming a target etched pattern through development and etching, resist coated on a material to be etched, on a substrate at a predetermined exposure;
obtaining difference information including at least one of a difference between a shape of the resist pattern and a shape of a target resist pattern, a difference between a shape of the etched pattern and a shape of the target etched pattern, and an element which causes the difference; and
correcting the processing pattern data and/or the predetermined exposure on the basis of the difference information.

23. An exposure method as defined in claim 22, wherein the difference information is obtained by comparing image information represented by the resist pattern and a shape of the target resist pattern and/or image information represented by the etched pattern and a shape of the target etched pattern.

24. An exposure method as defined in claim 22, wherein the difference information is obtained on the basis of condition of the developer and/or the etching liquid.

25. An exposure method as defined in claim 22, wherein the difference information is obtained on the basis of a number of times of development by the use of the same developer and/or a number of times of etching by the use of the same etching liquid.

26. An exposure method as defined in claim 22, wherein the difference information is obtained on the basis of the number of times of exposure.
